(19) United States
(12) Patent Application Publication
(10) Pub. No.: US 2025/0390256 A1
(43) Pub. Date: Dec. 25, 2025

(54) INFORMATION PROCESSING SYSTEM, INFORMATION PROCESSING APPARATUS, AND INFORMATION PROCESSING METHOD

(71) Applicant: Yoshihiko ABE, Kanagawa (JP)

(72) Inventor: Yoshihiko ABE, Kanagawa (JP)

(21) Appl. No.: 19/234,294

(22) Filed: Jun. 11, 2025

(30) Foreign Application Priority Data
Jun. 21, 2024 (JP) 2024-100585
Mar. 25, 2025 (JP) 2025-050265

(51) Int. Cl. G06F 3/12; G06T 5/60; G06T 7/00; H04N 1/60

(52) U.S. Cl. CPC G06F 3/1208; G06F 3/1256; G06T 5/60; G06T 7/0004; H04N 1/6011; G06T 2200/24; G06T 2207/20081; G06T 2207/30144; G06T 2207/30168

(57) ABSTRACT

An information processing system includes circuitry to acquire job information related to one or more image forming apparatuses on which image quality adjustment are performed and history information of an interaction between a user and a service provider of a service for solving a problem related to the image quality adjustment; obtain a candidate handling method for the problem in response to an assistance request for the problem according to a user operation by using the job information and the history information, the candidate handling method being obtained from a learning model to infer a candidate handling method for the problem; cause a display device of the service provider to display the candidate handling method on an assistance screen; and send a notification indicating a response made by the service provider in response to the assistance request based on the candidate handling method.

### CROSS-REFERENCE TO RELATED APPLICATIONS

This patent application is based on and claims priority pursuant to 35 U.S.C. § 119 (a) to Japanese Patent Application Nos. 2024-100585, filed on Jun. 21, 2024, and 2025-050265, filed on Mar. 25, 2025, in the Japan Patent Office, the entire disclosure of each are hereby incorporated by reference herein.

### BACKGROUND

### Technical Field

The present disclosure relates to an information processing system, an information processing apparatus, and an information processing method.

### Related Art

Conventional color adjustment for a printer that executes a print job includes color sample matching for matching a color reproduced by the printer to the color of a print sample present as a printed product, and processing for reading a printed color chart using a colorimeter and adjusting the printed output to achieve a color difference as a quality target. Such color adjustment is expected to be performed by a user themselves with dedicated software or the like by using a result of color measurement by the colorimeter, and involves high expertise and experience. Thus, if the color adjustment is performed by a low-skilled operator, the result of the color adjustment varies. Such an issue is common in general image quality adjustment including the color adjustment and the adjustment of density unevenness.

### SUMMARY

The present disclosure described herein provides an information processing system. The information processing system includes circuitry that acquires job information related to one or more image forming apparatuses on which image quality adjustment are performed and history information of an interaction between a user of the one or more image forming apparatuses and a service provider of a service for solving a problem related to the image quality adjustment, obtains a candidate handling method for the problem related to the image quality adjustment, in response to an assistance request for the problem related to the image quality adjustment according to an operation performed by the user, by using the job information and the history information, the candidate handling method being obtained from a learning model generated by machine learning to infer a candidate handling method for the problem related to the image quality adjustment, causes a display device used by the service provider to display the obtained candidate handling method on an assistance screen, the assistance screen displaying information for assisting in solving the problem related to the image quality adjustment, and send a notification indicating a response made by the service provider in response to the assistance request for the problem related to the image quality adjustment, the response being based on the displayed candidate handling method.

The present disclosure described herein provides an information processing apparatus communicable with an image quality adjustment system that performs image quality adjustment on one or more image forming apparatuses. The information processing apparatus includes circuitry. The circuitry acquires job information related to the one or more image forming apparatuses and history information of an interaction between a user of the one or more image forming apparatuses and a service provider providing a service for solving a problem related to the image quality adjustment, receives an assistance request for the problem related to the image quality adjustment from the image quality adjustment system based on an operation performed by the user, performs a search request to obtain a candidate handling method for the problem related to the image quality adjustment in response to the assistance request by using at least the job information and the history information, the candidate handling method being obtained from a learning model generated by machine learning to infer a candidate handling method for the problem related to the image quality adjustment, causes a display device used by the service provider to display the obtained candidate handling method on an assistance screen, the assistance system displaying information for assisting in solving the problem related to the image quality adjustment, and notifies the image quality adjustment system of a response made by the service provider in response to the assistance request for the problem related to the image quality adjustment, the response being based on the displayed candidate handling method.

The present disclosure described herein provides an information processing method for providing a service for solving a problem related to image quality adjustment performed on one or more image forming apparatuses. The information processing method includes acquiring job information related to the one or more image forming apparatuses and history information of an interaction between a user of the one or more image forming apparatuses and a service provider of the service; receiving an assistance request for the problem related to the image quality adjustment from the image quality adjustment system based on an operation performed by the user; obtaining a candidate handling method for the problem related to the image quality adjustment in response to the assistance request by using at least the job information and the history information, the candidate handling method being obtained from a learning model generated by machine learning to infer a candidate handling method for the problem related to the image quality adjustment; displaying, on a display device used by the service provider, the obtained candidate handling method on an assistance screen, the assistance screen displaying information for assisting in solving the problem related to the image quality adjustment; and notifying the image quality adjustment system of a response made by the service provider in response to the assistance request for the problem related to the image quality adjustment, the response being based on the displayed candidate handling method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of an information processing system;

FIG. 2 is a diagram illustrating an example hardware configuration of an image forming apparatus;

FIG. 3 is a diagram illustrating an example hardware configuration of a color adjustment system and the like;

FIG. 4 is a diagram illustrating an example functional configuration of the information processing system illustrated in FIG. 1;

FIG. 5 is a diagram illustrating an example overview of the operation of the information processing system illustrated in FIG. 4;

FIG. 6 is a diagram illustrating an example of color adjustment history information;

FIG. 7 is a diagram illustrating an example of operation history information;

FIG. 8 is a diagram illustrating an example configuration of a database;

FIG. 9 is a diagram illustrating an example of an operation of extracting a phenomenon, a cause, a handling method, and a result from a support history;

FIG. 10 is a diagram illustrating an example of causes and handling methods for problems related to job color adjustment;

FIG. 11 is a diagram illustrating an example of a device color adjustment result screen displayed by a print service provider;

FIG. 12 is a diagram illustrating an example of a job color adjustment result screen displayed by the print service provider;

FIG. 13 is a diagram illustrating an example of an assistance request screen displayed by the print service provider;

FIG. 14 is a diagram illustrating an example of a device color adjustment assistance screen (adjustment result tab) displayed by a service provider;

FIG. 15 is a diagram illustrating an example of a device color adjustment assistance screen (analysis tab) displayed by the service provider;

FIG. 16 is a diagram illustrating an example of a device color adjustment assistance screen (log tab) displayed by the service provider;

FIG. 17 is a diagram illustrating an example of a device color adjustment assistance screen (assist tab) displayed by the service provider;

FIG. 18 is a diagram illustrating an example of a job color adjustment assistance screen (adjustment result tab) displayed by the service provider;

FIG. 19 is a diagram illustrating an example of a screen displayed in response to the pressing of the assist tab on the job color adjustment assistance screen displayed by the service provider;

FIG. 20 is a diagram illustrating an example of a job color adjustment assistance screen (assist tab) displayed by the service provider;

FIG. 21 is a diagram illustrating an example of an assistance request screen displayed in response to a receipt of a response from the service provider;

FIG. 22 is a sequence diagram illustrating an example of a flow of an overall operation of the information processing system; and

FIG. 23 is a flowchart illustrating an example of a flow of an assist process for the information processing system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, an information processing apparatus, an information processing method, and a program according to an embodiment of the present disclosure will be described in detail hereinafter with reference to the drawings. The present disclosure is not limited to the following embodiments, and the constituent elements of the following embodiments include those that can be easily conceived by those skilled in the art, those being substantially the same ones, and those being within equivalent ranges.

Furthermore, various omissions, substitutions, changes, and combinations of the constituent elements may be made without departing from the gist of the following one or more embodiments.

### General Arrangement of Information Processing System

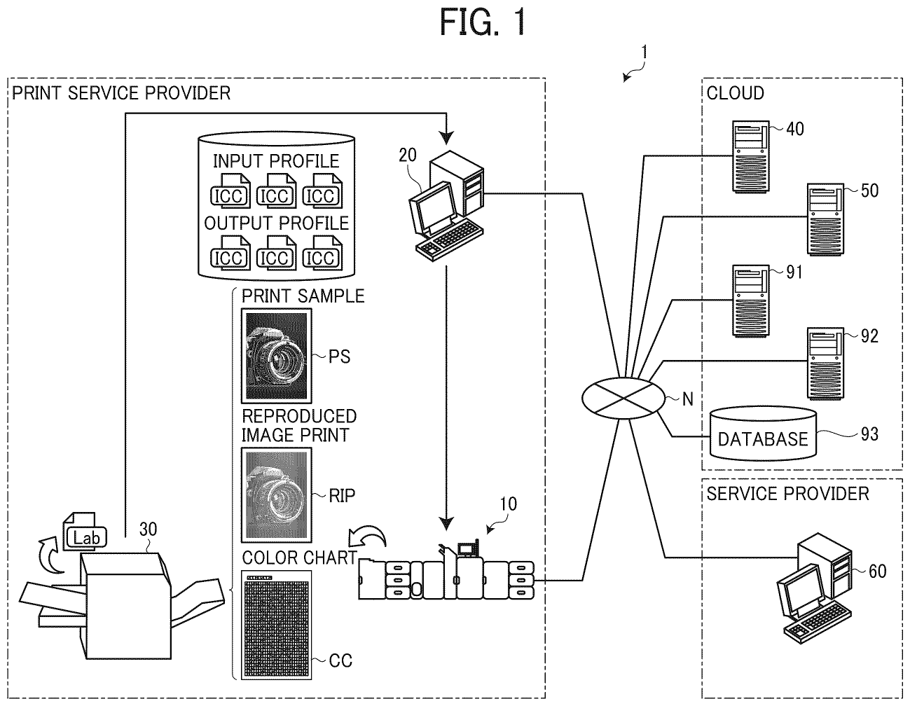

FIG. 1 is a diagram illustrating an example of a general arrangement of an information processing system 1. The general arrangement of the information processing system 1 will be described with reference to FIG. 1.

The information processing system 1 illustrated in FIG. 1 is a system for implementing two-way communication. Specifically, in the information processing system 1, when a print service provider performs color adjustment using a print sample PS, a color chart CC, and the like, the print service provider requests assistance from a service provider. In response to the request, the service provider provides guidance, a comment, and the like. The assistance refers to providing help, support, care, or the like. As illustrated in FIG. 1, the information processing system 1 includes an image forming apparatus 10, a color adjustment system 20, an image reading device 30, a color adjustment assistance system 40, a device management system 50, a service provider terminal 60, an image analysis system 91, a similar case search system 92, and a database 93. The image forming apparatus 10, the color adjustment system 20, the color adjustment assistance system 40, the device management system 50, the service provider terminal 60, the image analysis system 91, the similar case search system 92, and the database 93 can perform data communication with each other via a network N. While one image forming apparatus 10 is illustrated in FIG. 1 to simplify the description, the number of image forming apparatuses 10 is not limited to one, and a plurality of image forming apparatuses 10 may be managed by the color adjustment system 20. The information processing system 1 is not limited to including systems (i.e., the image forming apparatus 10, the color adjustment system 20, and the image reading device 30) of a single print service provider, and may include systems of a plurality of print service providers.

The image forming apparatus 10 is an image forming apparatus to be subjected to color adjustment, such as a commercial printing machine, a multifunction peripheral (MFP), or an electrophotographic or inkjet printing machine having a printer function as a main function. The MFP refers to a multifunction peripheral having at least two functions among a copying function, a printer function, a scanner function, and a facsimile function. The color adjustment includes color sample matching referred to as job color adjustment in which the image reading device 30 reads the print sample PS serving as a color reproduction sample for each print job and the read data is used to match the product of the print job to the color of the print sample PS. The color adjustment further includes processing referred to as device color adjustment in which the image reading device 30 reads, for each image forming apparatus 10 (or for each sheet printed and output from the image forming apparatus 10), the color chart CC printed and output from the image forming apparatus 10 and the read data is used to reduce in-plane unevenness. The job color adjustment generates an input profile for the purpose of color conversion to convert color values of document data included in a job into color values in a device-independent color space (such as L*a*b* values or XYZ values). The device color adjustment generates an output profile for the purpose of color conversion from the device-independent color space into a color space for printing by the image forming apparatus 10. The input profile and the output profile may be collectively referred to simply as profiles unless distinguished from each other.

The color adjustment system 20 is a system such as a personal computer (PC) or a workstation that performs color adjustment using read data obtained by reading, with the image reading device 30, the print sample PS of a job or the color chart CC printed and output from the image forming apparatus 10. The color adjustment system 20 also manages document data intended for printing by the image forming apparatus 10. The color adjustment system 20 may be implemented by a single information processing apparatus or may be implemented by a system including a plurality of information processing apparatuses.

Specifically, the color adjustment system 20 executes the job color adjustment by using read data obtained by reading the print sample PS of a job with the image reading device 30 to generate an input profile, and transmits the input profile to the image forming apparatus 10. The color adjustment system 20 further executes the device color adjustment by using read data obtained by reading, with the image reading device 30, the color chart CC printed and output from the image forming apparatus 10 to generate an output profile, and transmits the output profile to the image forming apparatus 10. The image forming apparatus 10 uses the received input profile and output profile to print the document data.

The image reading device 30 is a device that performs a reading process on the print sample PS and the color chart CC printed and output from the image forming apparatus 10 to generate read data including measured color values such as L*a*b* values, XYZ values, or RGB values. The image reading device 30 transmits the read data to the color adjustment system 20. Examples of the image reading device 30 include, but are not limited to, devices such as an image scanner and a colorimeter, and the image reading device 30 refers to any device that can acquire read data of the print sample PS and the color chart CC. In the present embodiment, the measured color values of the read data obtained by the reading process performed by the image reading device 30 are described as L*a*b* values of the L*a*b* colorimetric system (hereinafter simply referred to as “Lab values”). The read data obtained by the image reading device 30 is not limited to measured color values such as Lab values. The image reading device 30 may transmit the read data to the color adjustment system 20 as raw data, and the color adjustment system 20 may convert the raw data into measured color values.

The image reading device 30 also performs a reading process on a reproduced image print RIP. The reproduced image print RIP is a printed product obtained by the image forming apparatus 10 and representing document data of a job corresponding to the print sample PS. The read data of the reproduced image print RIP is used for the job color adjustment by the color adjustment system 20.

The color adjustment assistance system 40 collects information (hereinafter also referred to as “adjustment-related information”) such as the profiles generated by the color adjustment system 20, the read data of the print sample PS, the reproduced image print RIP, and the color chart CC read by the image reading device 30, the document data printed by the image forming apparatus 10, an operation history for the image forming apparatus 10 and the color adjustment system 20, a history of color adjustment performed by the color adjustment system 20, information (target device information) on the image forming apparatus 10 to be subjected to color adjustment, and a comment, an attached file, and the like to be exchanged (transmitted and received) between the color adjustment system 20 and the color adjustment assistance system 40. When an assistance request is received from the color adjustment system 20, the color adjustment assistance system 40 transmits a response to the request, based on the adjustment-related information, to the color adjustment system 20 via the service provider terminal 60. The comment to be exchanged (transmitted and received) between the color adjustment system 20 and the color adjustment assistance system 40 (i.e., history information of interactions between a user of the image forming apparatus 10 and the service provider) may be hereinafter referred to as a support history. The color adjustment assistance system 40 may be implemented by a single information processing apparatus or may be implemented by a system including a plurality of information processing apparatuses.

The device management system 50 collects information (hereinafter also referred to as device-related information) such as the operating status of the image forming apparatus 10, a history of errors that have occurred in the image forming apparatus 10, document data, and print settings information of the color chart CC, and provides the device-related information in accordance with a request from the color adjustment assistance system 40. The print settings information includes, for example, the name of the image forming apparatus 10, and information on media and ink to be used. The device management system 50 may be implemented by a single information processing apparatus or may be implemented by a system including a plurality of information processing apparatuses.

The image analysis system 91 is a system that performs image analysis related to color adjustment on the document data and the read data of the print sample PS and the reproduced image print RIP in accordance with a request from the color adjustment assistance system 40. The image analysis system 91 transmits image analysis information indicating the result of the image analysis to the color adjustment assistance system 40. The image analysis information includes, for example, an average color difference and a maximum color difference before the job color adjustment, a density value near the maximum color difference, the number of feature points, an image area, the number of colors, the number of out-of-gamut pixels, and an image pattern.

The similar case search system 92 is a system that uses a learning model generated by machine learning to search for a similar case related to a problem with the job color adjustment, based on job information described below, the image analysis information, and the support history, and presents candidate handling methods in accordance with a request from the color adjustment assistance system 40.

The database 93 is a database for managing job information described below and the like.

The color adjustment assistance system 40, the device management system 50, the image analysis system 91, the similar case search system 92, and the database 93 described above are systems implemented on a cloud-based platform and managed by a service provider that provides a service for providing responses such as guidance in response to a request for assistance with color adjustment by the color adjustment system 20. In one example, the color adjustment assistance system 40, the device management system 50, the image analysis system 91, the similar case search system 92, and the database 93 are not separate systems, and at least one of them is the same system.

The service provider terminal 60 is an information terminal for a service provider with expertise in color adjustment to input a response to an assistance request from the color adjustment system 20, which is sent via the color adjustment assistance system 40, based on the adjustment-related information and the device-related information provided from the color adjustment assistance system 40.

### Hardware Configuration of Image Forming Apparatus

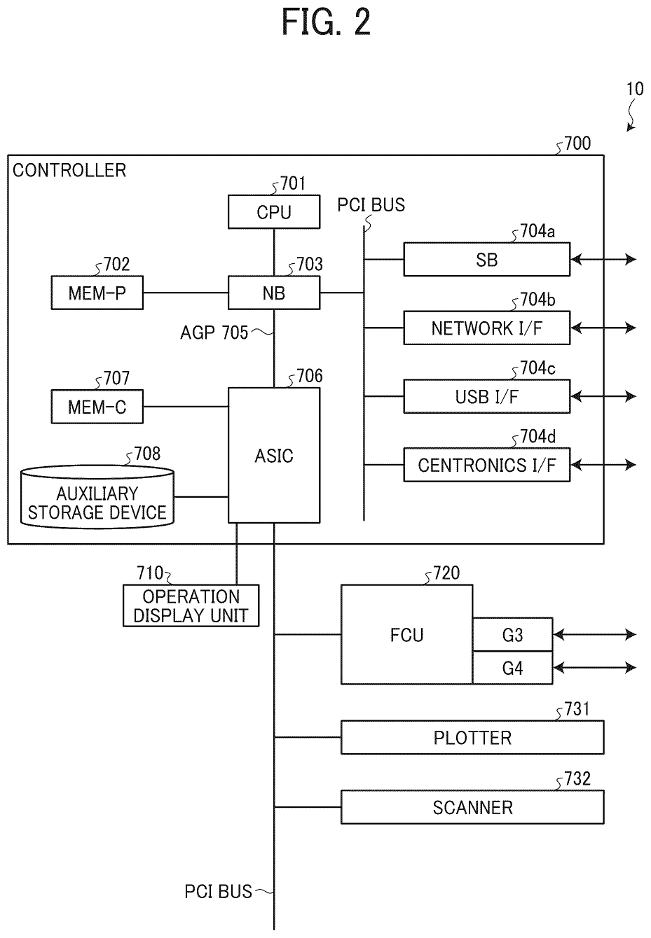

FIG. 2 is a diagram illustrating an example hardware configuration of the image forming apparatus 10. The hardware configuration of the image forming apparatus 10 will be described with reference to FIG. 2. While the image forming apparatus 10 is described as an MFP in FIG. 2, the image forming apparatus 10 may be a commercial printing machine, an electrophotographic or inkjet printing machine having a printer function as a main function, or any other device having a basic configuration similar to the configuration illustrated in FIG. 2.

As illustrated in FIG. 2, the image forming apparatus 10 includes a controller 700, an operation display unit 710, a facsimile control unit (FCU) 720, a plotter 731 (printing device), and a scanner 732, which are connected to each other via a peripheral component interconnect (PCI) bus.

The controller 700 is a device for performing overall control of the image forming apparatus 10 and controlling drawing and communication of the image forming apparatus 10, and input from the operation display unit 710.

The operation display unit 710 is a device such as a touch panel that receives an input to the controller 700 (input function) and displays the state and the like of the image forming apparatus 10 (display function). The operation display unit 710 is directly connected to an application specific integrated circuit (ASIC) 706 described below.

The FCU 720 is a device that implements a facsimile function, and is connected to the ASIC 706 via, for example, the PCI bus.

The plotter 731 is a device that implements a printing function, and is connected to the ASIC 706 via, for example, the PCI bus. The scanner 732 is a device that implements a scanner function, and is connected to the ASIC 706 via, for example, the PCI bus.

The controller 700 includes a central processing unit (CPU) 701, a system memory (MEM-P) 702, a northbridge (NB) 703, a southbridge (SB) 704a, a network interface (I/F) 704b, a universal serial bus (USB) I/F 704c, a Centronics I/F 704d, the ASIC 706, a local memory (MEM-C) 707, and an auxiliary storage device 708.

The CPU 701 performs overall control of the image forming apparatus 10. The CPU 701 is connected to a chipset including the system memory 702, the northbridge 703, and the southbridge 704a, and is connected to other devices via the chipset.

The system memory 702 is a memory for storing programs and data, loading programs and data, and storing drawing data for a printer. The system memory 702 includes a read-only memory (ROM) and a random-access memory (RAM). The ROM is a read-only memory for storing programs and data. The RAM is a random-access memory, or in other words, a writable and readable memory used as, for example, a memory for loading programs and data and a memory for storing drawing data for the printer.

The northbridge 703 is a bridge for connecting the CPU 701 to the system memory 702, the southbridge 704a, and an accelerated graphics port (AGP) bus 705, and includes a memory controller that controls, for example, reading and writing data from and to the system memory 702, a PCI master, and an AGP target.

The southbridge 704a is a bridge for connecting the northbridge 703 to PCI devices and peripheral devices. The southbridge 704a is connected to the northbridge 703 via a PCI bus, and the PCI bus is connected to the network I/F 704b, the USB I/F 704c, and the Centronics I/F 704d, for example.

The network I/F 704b is an interface for communicating data with an external device, such as the color adjustment system 20, via the network N. The network I/F 704b supports, for example, Ethernet® and can perform communication compliant with, for example, Transmission Control Protocol (TCP)/Internet Protocol (IP). The network I/F 704b may be a wireless communication interface compliant with, for example, Wi-Fi®.

The USB I/F 704c is an interface that can communicate with a device compliant with the USB standard.

The Centronics I/F 704d is an interface having the specifications of a parallel port that allows transmission of a plurality of bits.

The AGP bus 705 is a bus interface for a graphics accelerator card proposed to speed up graphics processing. The AGP bus 705 can speed up the graphics accelerator card by directly accessing the system memory 702 with high throughput.

The ASIC 706 is an integrated circuit (IC) for image processing applications having hardware elements for image processing. The ASIC 706 serves as a bridge for connecting the AGP bus 705, the PCI bus, the auxiliary storage device 708, and the local memory 707 to one another. The ASIC 706 includes a PCI target, an AGP master, an arbiter (ARB) serving as the core of the ASIC 706, a memory controller that controls the local memory 707, a plurality of direct memory access controllers (DMACs) that rotate image data using hardware logic or the like, and a PCI unit that transfers data to and from the plotter 731 and the scanner 732 via a PCI bus. The ASIC 706 is connected to the FCU 720, the plotter 731, and the scanner 732 via, for example, the PCI bus. The ASIC 706 is also connected to a host PC and a network, for example.

The local memory 707 is used as an image buffer for copying and a code buffer.

The auxiliary storage device 708 is a storage device such as a hard disk drive (HDD), a solid state drive (SSD), a Secure Digital (SD) card, or a flash memory. The auxiliary storage device 708 stores image data, programs, font data, and forms, for example.

The program designed for the image forming apparatus 10 described above may be recorded on a computer-readable recording medium, such as the auxiliary storage device 708, for distribution in an installable or executable file format.

The hardware configuration of the image forming apparatus 10 illustrated in FIG. 2 is an example. Not all of the components illustrated in FIG. 2 may be included, or some other components may be included.

### Hardware Configuration of Color Adjustment System

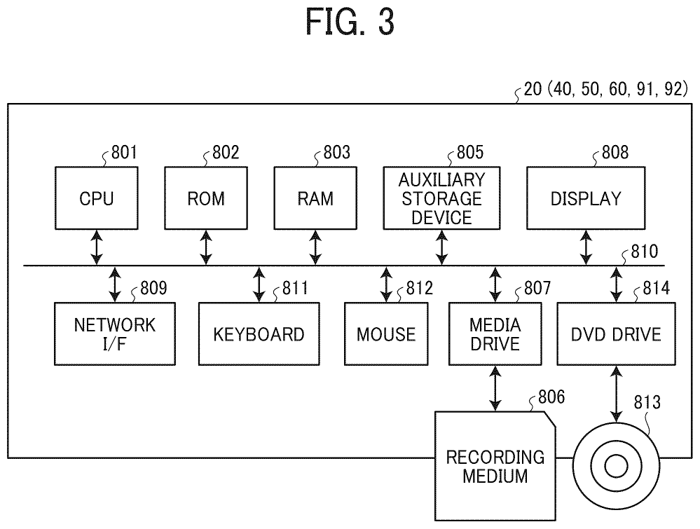

FIG. 3 is a diagram illustrating an example hardware configuration of the color adjustment system 20 and the like. The hardware configuration of the color adjustment system 20 will be described with reference to FIG. 3. The hardware configurations of the color adjustment assistance system 40, the device management system 50, the service provider terminal 60, the image analysis system 91, and the similar case search system 92 are also similar to the configuration illustrated in FIG. 3.

As illustrated in FIG. 3, the color adjustment system 20 includes a CPU 801, a ROM 802, a RAM 803, an auxiliary storage device 805, a media drive 807, a display 808, a network I/F 809, a keyboard 811, a mouse 812, and a digital versatile disc (DVD) drive 814.

The CPU 801 is an arithmetic device that controls the overall operation of the color adjustment system 20. The ROM 802 is a non-volatile storage device that stores a program for the color adjustment system 20. The RAM 803 is a volatile storage device used as a work area for the CPU 801.

The auxiliary storage device 805 is a storage device such as an HDD or an SSD that stores, for example, various kinds of data and programs. The media drive 807 is a device that controls reading and writing of data from and to a recording medium 806, such as a flash memory, under the control of the CPU 801.

The display 808 is a display device such as a liquid crystal display or an organic electro-luminescence (EL) display that displays various kinds of information such as a cursor, a menu, a window, characters, or an image.

The network I/F 809 is an interface for communicating data with the image forming apparatus 10, the image reading device 30, and the like via an internal network (such as a local area network (LAN)) of the print service provider and communicating data with the color adjustment assistance system 40, the device management system 50, and the like via the network N. The network I/F 809 is, for example, a network interface card (NIC) that supports Ethernet® and can perform communication compliant with, for example, TCP/IP. The network I/F 809 may be a wireless communication interface compliant with, for example, Wi-Fi®. An interface for the internal network described above and an interface for the network N may be separate from each other.

The keyboard 811 is an example of an input device used for selecting characters, numbers, or various instructions and moving a cursor, for example. The mouse 812 is an example of an input device used for selecting and executing various instructions, selecting a subject to be processed, and moving the cursor, for example.

The DVD drive 814 is a device that controls reading and writing of data from and to a DVD 813, such as a digital versatile disc read-only memory (DVD-ROM) or a digital versatile disc recordable (DVD-R), as an example of a removable storage medium.

The CPU 801, the ROM 802, and the RAM 803, the auxiliary storage device 805, the media drive 807, the display 808, the network I/F 809, the keyboard 811, the mouse 812, and the DVD drive 814 described above are communicably connected to each other via a bus 810 such as an address bus or a date bus.

The hardware configurations of the color adjustment system 20, the color adjustment assistance system 40, the device management system 50, the service provider terminal 60, the image analysis system 91, and the similar case search system 92 illustrated in FIG. 3 are merely an example, and not all of the components illustrated in FIG. 3 may be included, or some other components may be included.

### Functional Configuration and Operation of Information Processing System

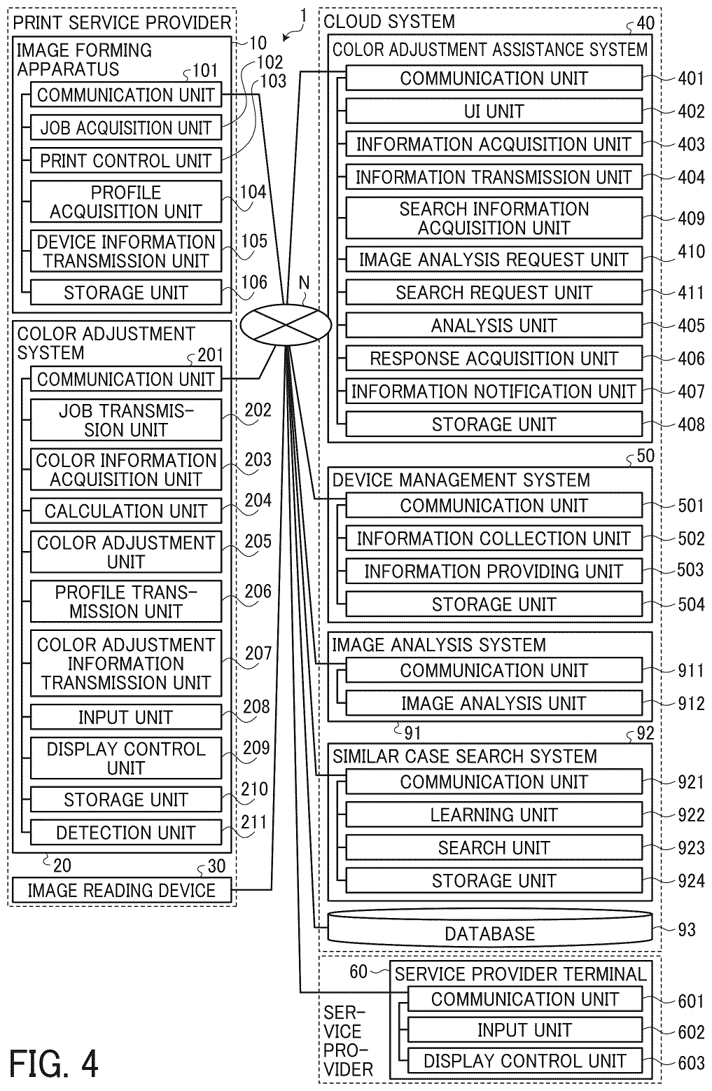

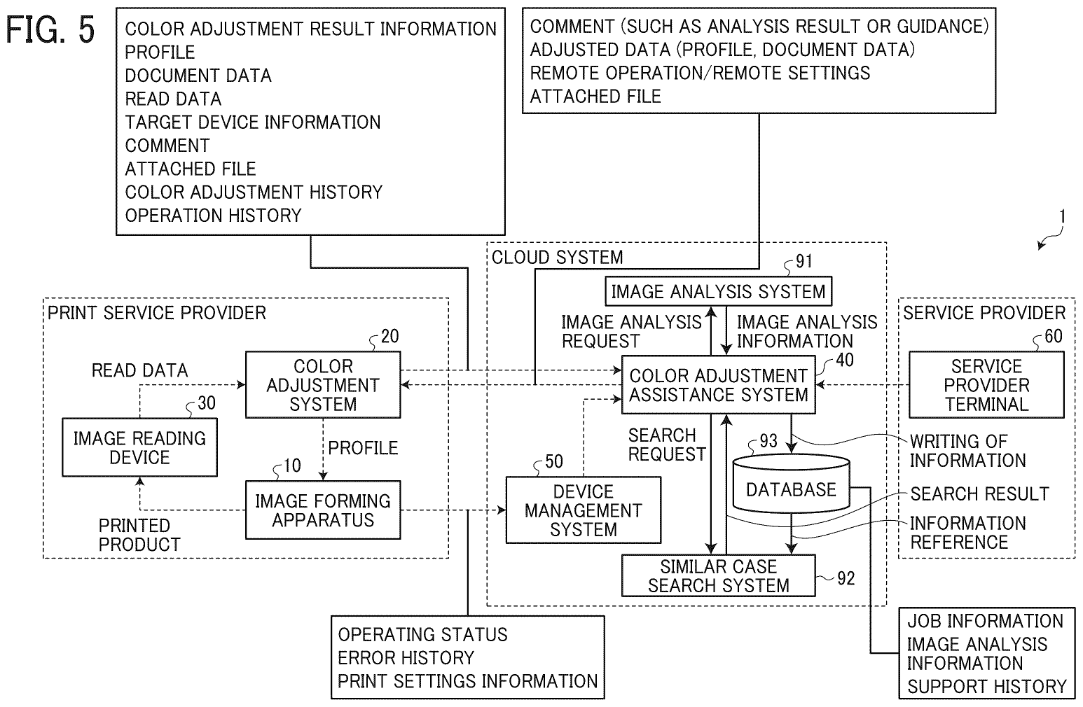

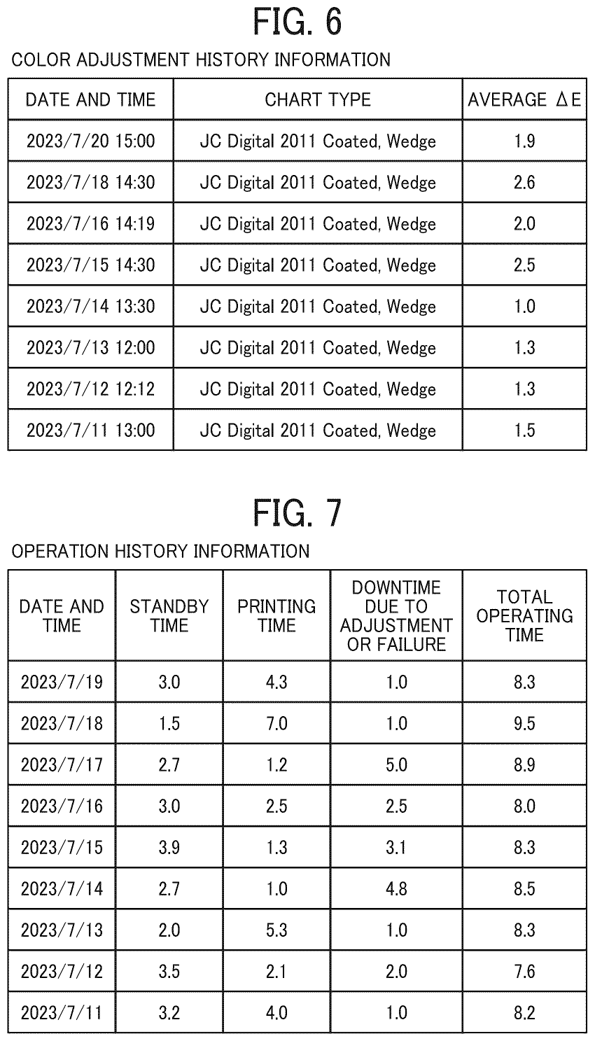

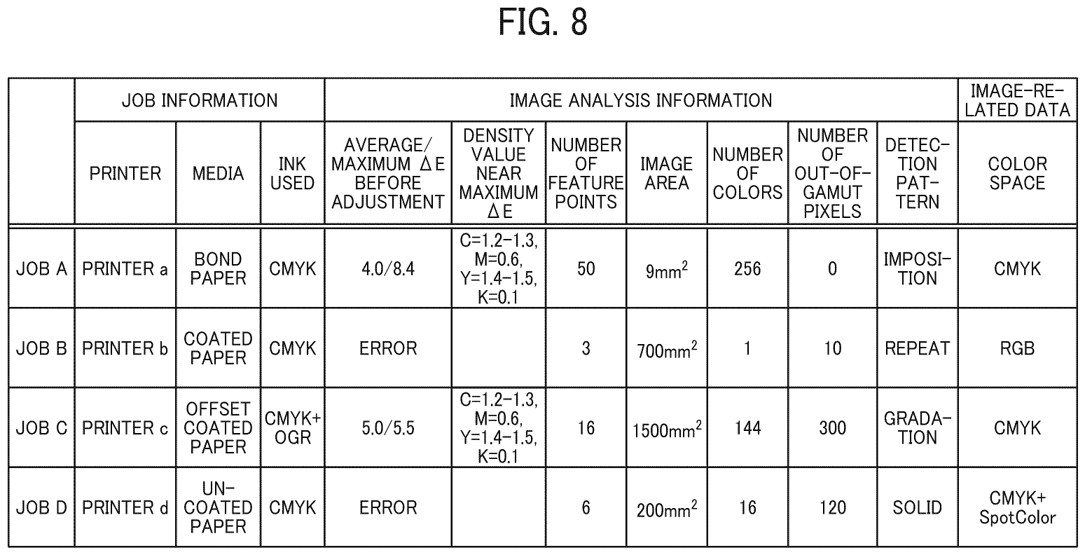

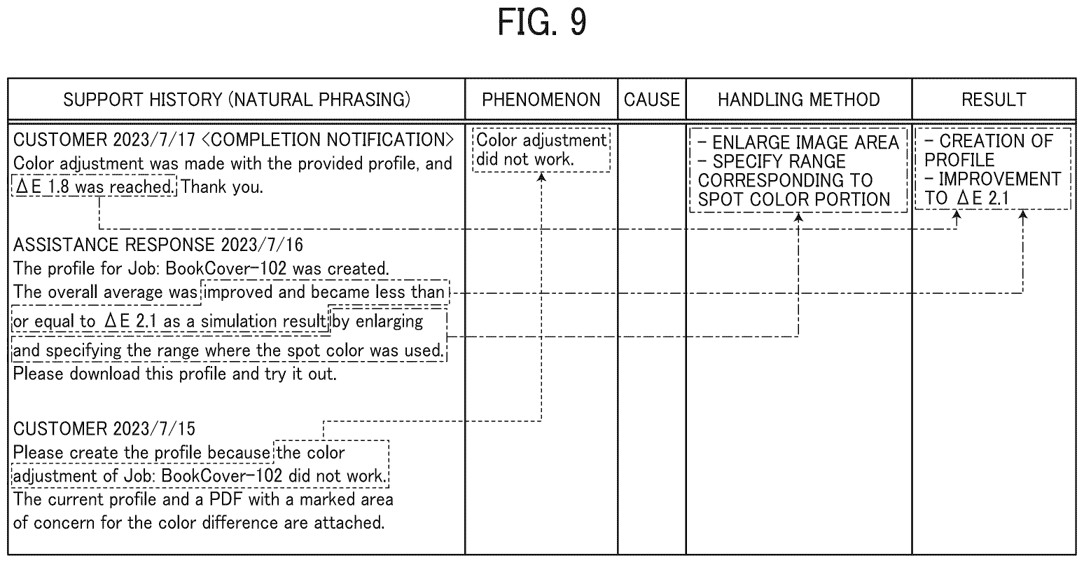

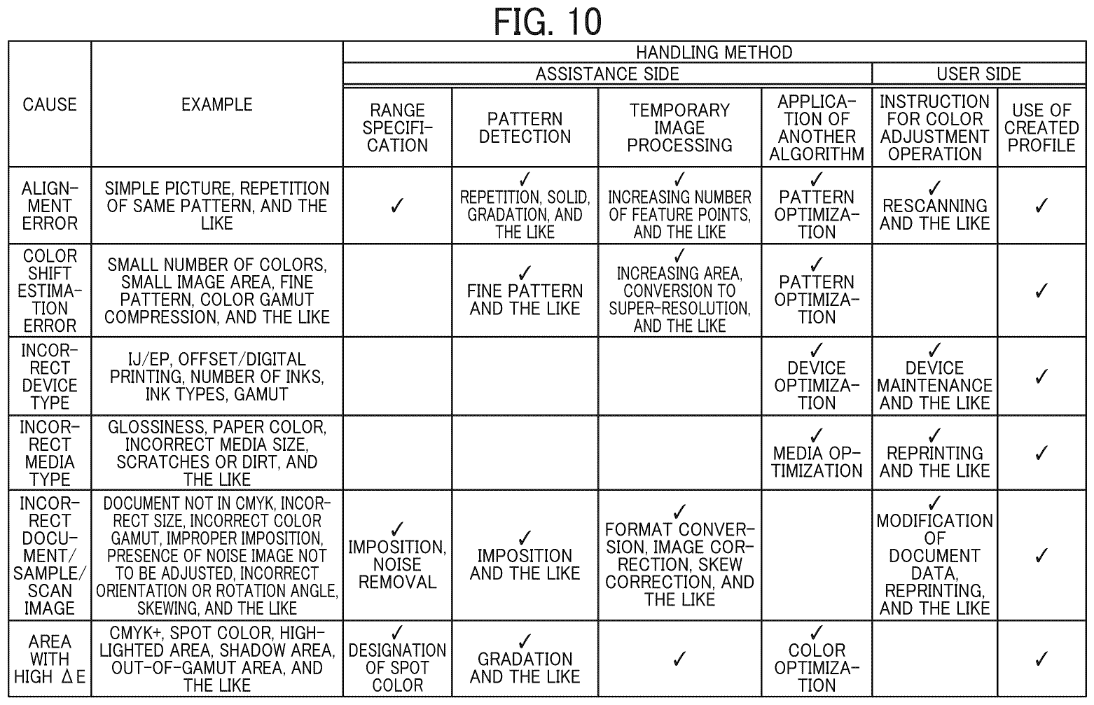

FIG. 4 is a diagram illustrating an example functional configuration of the information processing system 1. FIG. 5 is a diagram illustrating an overview of the operation of the information processing system 1 illustrated in FIG. 4. FIG. 6 is a diagram illustrating an example of color adjustment history information. FIG. 7 is a diagram illustrating an example of operation history information. FIG. 8 is a diagram illustrating an example configuration of the database 93. FIG. 9 is a diagram illustrating an example of an operation of extracting a phenomenon, a cause, a handling method, and a result from the support history. FIG. 10 is a diagram illustrating an example of causes and handling methods for problems related to the job color adjustment. The functional configuration and operation of the information processing system 1 will be described with reference to FIGS. 4 to 10.

As illustrated in FIG. 4, the image forming apparatus 10 includes a communication unit 101, a job acquisition unit 102, a print control unit 103, a profile acquisition unit 104, a device information transmission unit 105, and a storage unit 106.

The communication unit 101 is a functional unit that performs data communication with the color adjustment system 20 and the device management system 50. The communication unit 101 is implemented by the network I/F 704b and the CPU 701 illustrated in FIG. 2 in response to execution of a program.

The job acquisition unit 102 is a functional unit that acquires document data and a print job for the color chart CC from the color adjustment system 20. The job acquisition unit 102 further acquires normal print jobs from external devices via the network N. The job acquisition unit 102 is implemented by, for example, the CPU 701 illustrated in FIG. 2 executing a program.

The print control unit 103 is a functional unit that controls the plotter 731 to perform printing based on a print job for document data acquired by the job acquisition unit 102 and output a reproduced image print by applying the profiles generated by the color adjustment system 20. The print control unit 103 further controls the plotter 731 to print the color chart CC, based on a print job for the color chart CC acquired by the job acquisition unit 102.

Further, the print control unit 103 causes a history indicating the operating status of the image forming apparatus 10 to be stored in the storage unit 106 as the operation history information illustrated in FIG. 7. The operation history information is a portion of the device-related information described above. The operation history information illustrated in FIG. 7 as an example is history information in which the standby time, the printing time, the downtime due to color adjustment or failure, and the total operating time of the image forming apparatus 10 are associated with each other.

The print control unit 103 is implemented by, for example, the CPU 701 illustrated in FIG. 2 executing a program.

The profile acquisition unit 104 is a functional unit that acquires, via the communication unit 101, an input profile and an output profile generated by the color adjustment system 20 through color adjustment. The profile acquisition unit 104 stores (registers) the acquired profiles in the storage unit 106. The profiles stored in the storage unit 106 are used by the print control unit 103 to control printing to paper. The profile acquisition unit 104 is implemented by, for example, the CPU 701 illustrated in FIG. 2 executing a program.

The device information transmission unit 105 is a functional unit that collects device-related information of the image forming apparatus 10 and transmits the collected device-related information to the device management system 50 via the communication unit 101, as illustrated in FIG. 5. The device information transmission unit 105 is implemented by, for example, the CPU 701 illustrated in FIG. 2 executing a program.

The storage unit 106 is a functional unit that stores the profiles acquired by the profile acquisition unit 104, the device-related information, various types of data, programs, and the like. The storage unit 106 is implemented by the auxiliary storage device 708 illustrated in FIG. 2.

Of the functional units of the image forming apparatus 10 illustrated in FIG. 4, at least some of the functional units implemented by software (program) may be implemented by a hardware circuit such as a field-programmable gate array (FPGA) or an ASIC.

While the functional units of the image forming apparatus 10 illustrated in FIG. 4 are conceptually illustrated functions, the functional units are not limited to such a configuration. For example, two or more of the functional units of the image forming apparatus 10 illustrated as independent functional units in FIG. 4 may be integrated into a single functional unit. In contrast, a function of one functional unit in the image forming apparatus 10 illustrated in FIG. 4 may be divided into a plurality of functions and implemented as a plurality of functional units. The functional units of the image forming apparatus 10 are not necessarily implemented as distinct software modules illustrated as the blocks in FIG. 4, and the functions of the functional units may be implemented as a whole by the image forming apparatus 10 executing a program.

As illustrated in FIG. 4, the color adjustment system 20 includes a communication unit 201, a job transmission unit 202, a color information acquisition unit 203, a calculation unit 204, a color adjustment unit 205, a profile transmission unit 206, a color adjustment information transmission unit 207 (an example of a transmission unit), an input unit 208, a display control unit 209, a storage unit 210, and a detection unit 211.

The communication unit 201 is a functional unit that performs data communication with the image forming apparatus 10, the image reading device 30, and the color adjustment assistance system 40. The communication unit 201 is implemented by the network I/F 809 and the CPU 801 illustrated in FIG. 3 in response to execution of a program.

The job transmission unit 202 is a functional unit that transmits document data and a print job for the color chart CC to the image forming apparatus 10 via the communication unit 201 such that the image forming apparatus 10 can print the document data and the print job for the color chart CC. The job transmission unit 202 is implemented by, for example, the CPU 801 illustrated in FIG. 3 executing a program.

The color information acquisition unit 203 is a functional unit that acquires read data from the image reading device 30 via the communication unit 201, as illustrated in FIG. 5. The read data includes measured color values (e.g., Lab values) obtained by the image reading device 30 performing a reading process on the reproduced image print RIP and the color chart CC, which are printed by the image forming apparatus 10, and on the print sample PS. The color information acquisition unit 203 is implemented by, for example, the CPU 801 illustrated in FIG. 3 executing a program.

The calculation unit 204 is a functional unit that calculates, in the job color adjustment, a color difference between an image of the print sample PS and a reproduction image obtained after the color matching and generates a color difference map. For example, the calculation unit 204 calculates a color difference between the pixel value of each pixel in the image of the print sample PS and the pixel value of the corresponding pixel in the reproduction image. The image of the print sample PS refers to an image displayed based on the read data of the print sample PS. The reproduction image refers to an image displayed based on the read data of the reproduced image print RIP. The color difference map is a map in which, for example, monochrome gradation is changed in accordance with the value of the color difference. In the job color adjustment, the calculation unit 204 further calculates a color difference between the image of the print sample PS and a reproduction image (i.e., a reproduction image obtained before the color matching) and generates a color difference map. The calculation unit 204 further calculates a color difference average that is an average value of these color differences. The color difference average of the color differences between the image of the print sample PS and the reproduction image obtained before the color matching may be referred to as pre-adjustment ΔE, and the color difference average of the color differences between the image of the print sample PS and the reproduction image obtained after the color matching may be referred to as post-adjustment ΔE.

In the device color adjustment, the calculation unit 204 calculates, from the read data of the color chart CC, an average value (average ΔE) and a maximum color difference (maximum ΔE) of color differences between patches.

The calculation unit 204 is implemented by, for example, the CPU 801 illustrated in FIG. 3 executing a program.

The color adjustment unit 205 is a functional unit that performs adjustment such that the colors of the reproduction image match the colors of the image of the print sample PS in the job color adjustment to generate an input profile. In the device color adjustment, since the color value of each patch of the color chart CC is known, the color adjustment unit 205 performs a color adjustment process according to a known technique such that the measured color values of patches corresponding to color adjustment patches reproduce the color values of the respective patches of the color chart CC, and creates an output profile. The color adjustment unit 205 is implemented by, for example, the CPU 801 illustrated in FIG. 3 executing a program.

The calculation unit 204 and the color adjustment unit 205 store the results of the job color adjustment and the device color adjustment in the storage unit 210 as the color adjustment history information illustrated in FIG. 6. The color adjustment history information is a portion of the adjustment-related information described above. The color adjustment history information illustrated in FIG. 6 as an example is an example of device color adjustment history information, and is history information in which the date and time at which the average ΔE was calculated by the calculation unit 204, the type (chart type) of the color chart CC used for the device color adjustment, and the average ΔE calculated by the calculation unit 204 are associated with each other.

The profile transmission unit 206 is a functional unit that transmits the profiles generated by the color adjustment unit 205 to the image forming apparatus 10 via the communication unit 201, as illustrated in FIG. 5. The profile transmission unit 206 is implemented by, for example, the CPU 801 illustrated in FIG. 3 executing a program.

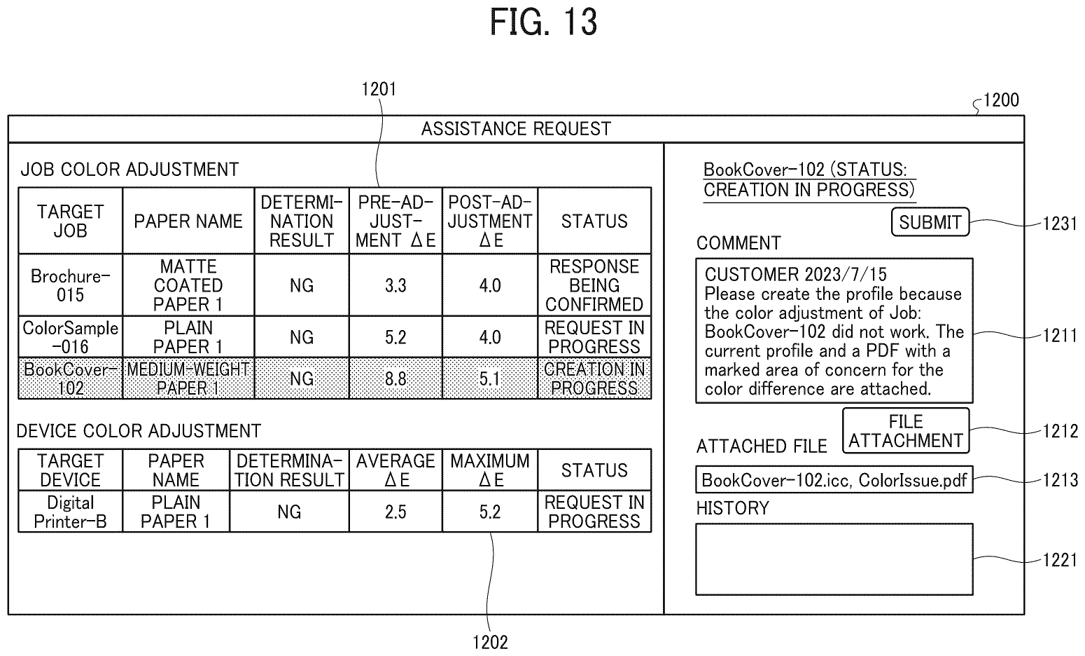

The color adjustment information transmission unit 207 is a functional unit that collects adjustment-related information related to the job color adjustment and the device color adjustment for the image forming apparatus 10 and transmits the collected adjustment-related information to the color adjustment assistance system 40 via the communication unit 201, as illustrated in FIG. 5. For example, when the detection unit 211 detects a problem with the job color adjustment or the device color adjustment, and when the user (print service provider) performs an operation of making an assistance request on an assistance request screen 1200 illustrated in FIG. 13 described below, the color adjustment information transmission unit 207 transmits the assistance request and the adjustment-related information to the color adjustment assistance system 40 via the communication unit 201. In one example, the user is the print service provider. The color adjustment information transmission unit 207 is implemented by, for example, the CPU 801 illustrated in FIG. 3 executing a program.

The input unit 208 is a functional unit that receives an input operation performed by the user (print service provider) on, for example, a device color adjustment result screen 1000 described below. The input unit 208 is implemented by the keyboard 811 and the mouse 812 illustrated in FIG. 3.

The display control unit 209 is a functional unit that controls the display 808 of the color adjustment system 20 to display various screens (e.g., the device color adjustment result screen 1000 described below) and information. The display control unit 209 is implemented by, for example, the CPU 801 illustrated in FIG. 3 executing a program.

The storage unit 210 is a functional unit that stores the adjustment-related information such as the document data, the data of the color chart CC, and the profiles generated by the color adjustment unit 205. The storage unit 210 is implemented by the auxiliary storage device 805 illustrated in FIG. 3.

The detection unit 211 is a functional unit that detects an “NG” (meaning No Good, indicating failure) result of the determination of the job color adjustment a predetermined number of consecutive times, and an “NG” result for the device color adjustment a predetermined number of consecutive times. For example, in the job color adjustment, the “NG” result is detected when the post-adjustment ΔE calculated by the calculation unit 204 becomes greater than or equal to a predetermined value, and in the device color adjustment, the “NG” result is detected when at least one of the average ΔE and the maximum ΔE calculated by the calculation unit 204 becomes greater than or equal to a predetermined value. The detection unit 211 is not limited to detecting an “NG” result of the determination of the job color adjustment or the device color adjustment a predetermined number of consecutive times as described above, and may detect a problem with the job color adjustment or the device color adjustment by confirming that a predetermined condition is satisfied. Examples of the predetermined condition include a case where the “NG” result occurs in a predetermined percentage of a predetermined number of color adjustments, and a case where the color difference calculated through color adjustment indicates an abnormal value exceeding an expected value.

Of the functional units of the color adjustment system 20 illustrated in FIG. 4, at least some of the functional units implemented by software (program) may be implemented by a hardware circuit such as an FPGA or an ASIC.

While the functional units of the color adjustment system 20 illustrated in FIG. 4 are conceptually illustrated functions, the functional units are not limited to such a configuration. For example, two or more of the functional units of the color adjustment system 20 illustrated as independent functional units in FIG. 4 may be integrated into a single functional unit. In contrast, a function of one functional unit in the color adjustment system 20 illustrated in FIG. 4 may be divided into a plurality of functions and implemented as a plurality of functional units. The functional units of the color adjustment system 20 are not necessarily implemented as distinct software modules illustrated as the blocks in FIG. 4, and the functions of the functional units may be implemented as a whole by the color adjustment system 20 executing a program.

In the foregoing description, the user (print service provider) performs an operation input on the device color adjustment result screen 1000 or the like displayed by the display control unit 209 of the color adjustment system 20 through the input unit 208 of the color adjustment system 20, but this is not meant to be limiting. For example, the device color adjustment result screen 1000 or the like may be displayed on an information terminal used by the user (print service provider) and configured to perform data communication with the color adjustment system 20, and an operation input may be performed on the displayed screen via the information terminal.

As illustrated in FIG. 4, the color adjustment assistance system 40 includes a communication unit 401, a user interface (UI) unit 402 (an example of a display control unit), an information acquisition unit 403, an information transmission unit 404, a search information acquisition unit 409 (acquisition unit), an image analysis request unit 410, a search request unit 411, an analysis unit 405, a response acquisition unit 406, an information notification unit 407, and a storage unit 408.

The communication unit 401 is a functional unit that performs data communication with the color adjustment system 20, the device management system 50, the service provider terminal 60, the image analysis system 91, and the similar case search system 92. The communication unit 401 is implemented by the network I/F 809 and the CPU 801 illustrated in FIG. 3 in response to execution of a program.

The UI unit 402 is a functional unit that provides screen information for the print service provider (user) to the color adjustment system 20 via the communication unit 401 and provides screen information for the service provider to the service provider terminal 60 via the communication unit 401. The screens provided by the UI unit 402 will be described in detail below. The UI unit 402 is implemented by, for example, the CPU 801 illustrated in FIG. 3 executing a program.

The information acquisition unit 403 is a functional unit that acquires the adjustment-related information from the color adjustment system 20 via the communication unit 401 and acquires the device-related information from the device management system 50 via the communication unit 401. The information acquisition unit 403 acquires the adjustment-related information from the color adjustment system 20, for example, periodically or in response to an assistance request from the color adjustment system 20. The information acquisition unit 403 is implemented by, for example, the CPU 801 illustrated in FIG. 3 executing a program.

The information transmission unit 404 is a functional unit that transmits the adjustment-related information and the device-related information acquired by the information acquisition unit 403 to the color adjustment system 20 and the service provider terminal 60 via the communication unit 401. The information transmission unit 404 is implemented by, for example, the CPU 801 illustrated in FIG. 3 executing a program.

The search information acquisition unit 409 is a functional unit that acquires job information and the support history from the information acquired by the information acquisition unit 403. The job information is related to a job for, for example, the document data and is information for which the job is executed, including the name of the image forming apparatus 10, media, and ink used. In one example, the job information is acquired from, for example, the print settings information described above. The search information acquisition unit 409 acquires the document data and the read data of the print sample PS and the reproduced image print RIP from the adjustment-related information acquired by the information acquisition unit 403. The search information acquisition unit 409 may automatically collect the information periodically. The search information acquisition unit 409 is implemented by, for example, the CPU 801 illustrated in FIG. 3 executing a program.

The image analysis request unit 410 is a functional unit that transmits an image analysis request to the image analysis system 91, together with the document data and the read data of the print sample PS and the reproduced image print RIP acquired by the search information acquisition unit 409, as illustrated in FIG. 5. Then, the image analysis request unit 410 receives image analysis information indicating the result of image analysis performed by the image analysis system 91. Further, the image analysis request unit 410 stores the document data and the read data of the print sample PS and the reproduced image print RIP acquired by the search information acquisition unit 409, and the image analysis information received from the image analysis system 91 in the database 93 in association with each other for each job, as illustrated in FIG. 8. In the configuration of the database 93 illustrated in FIG. 8, image-related data corresponds to the document data and the read data of the print sample PS and the reproduced image print RIP described above. The image analysis request unit 410 is implemented by, for example, the CPU 801 illustrated in FIG. 3 executing a program.

The search request unit 411 is a functional unit that transmits a request to search for a similar case related to a problem with the job color adjustment to the similar case search system 92, together with the job information and the support history acquired by the search information acquisition unit 409 and the image analysis information received by the image analysis request unit 410, as illustrated in FIG. 5. Further, the search request unit 411 receives a search result obtained by the similar case search system 92.

The analysis unit 405 is a functional unit that analyzes a color adjustment problem for the adjustment-related information and the device-related information acquired by the information acquisition unit 403. For example, the analysis unit 405 automatically generates a comment indicating an analysis result from the history of color adjustment in the adjustment-related information, and automatically generates a comment indicating a response proposal for the user (print service provider), based on the analysis result. The analysis unit 405 is implemented by, for example, the CPU 801 illustrated in FIG. 3 executing a program.

The response acquisition unit 406 is a functional unit that acquires, through the communication unit 401, at least one of a comment, a profile created and adjusted by the service provider, and an attached file such as document data, as a response to the assistance request from the service provider via the service provider terminal 60, as illustrated in FIG. 5. As illustrated in FIG. 5, furthermore, the response acquisition unit 406 can provide, as the response, a remote operation or a remote setting for the image forming apparatus 10 or the color adjustment system 20 from the service provider via the service provider terminal 60 in cooperation with the information notification unit 407. Such a remote operation or remote setting allows the service provider to directly address a problem with print settings, for example. Then, the response acquisition unit 406 adds the comment acquired in response to the assistance request to the support history acquired by the search information acquisition unit 409, and stores the resulting support history in the database 93 in association with the corresponding job. The response acquisition unit 406 is implemented by, for example, the CPU 801 illustrated in FIG. 3 executing a program.

The information notification unit 407 is a functional unit that notifies the color adjustment system 20 of the response acquired by the response acquisition unit 406 via the communication unit 401. The information notification unit 407 is implemented by, for example, the CPU 801 illustrated in FIG. 3 executing a program.

The storage unit 408 is a functional unit that stores the adjustment-related information and the device-related information acquired by the information acquisition unit 403, the response acquired by the response acquisition unit 406, and the like. That is, the adjustment-related information acquired from the color adjustment system 20 and the device-related information acquired from the device management system 50 are aggregated in the storage unit 408, and screens displayed on the color adjustment system 20 and the service provider terminal 60 are based on the adjustment-related information and the device-related information, as described below. Thus, the user (print service provider) and the service provider can share the adjustment-related information and the device-related information. The adjustment-related information and the device-related information aggregated in the storage unit 408 construct a knowledge base that can be used to solve problems in the future. The storage unit 408 is implemented by the auxiliary storage device 805 illustrated in FIG. 3.

Of the functional units of the color adjustment assistance system 40 illustrated in FIG. 4, at least some of the functional units implemented by software (program) may be implemented by a hardware circuit such as an FPGA or an ASIC.

While the functional units of the color adjustment assistance system 40 illustrated in FIG. 4 are conceptually illustrated functions, the functional units are not limited to such a configuration. For example, two or more of the functional units of the color adjustment assistance system 40 illustrated as independent functional units in FIG. 4 may be integrated into a single functional unit. In contrast, a function of one functional unit in the color adjustment assistance system 40 illustrated in FIG. 4 may be divided into a plurality of functions and implemented as a plurality of functional units. The functional units of the color adjustment assistance system 40 are not necessarily implemented as distinct software modules illustrated as the blocks in FIG. 4, and the functions of the functional units may be implemented as a whole by the color adjustment assistance system 40 executing a program.

As illustrated in FIG. 4, the device management system 50 includes a communication unit 501, an information collection unit 502, an information providing unit 503, and a storage unit 504.

The communication unit 501 is a functional unit that performs data communication with the image forming apparatus 10 and the color adjustment assistance system 40. The communication unit 501 is implemented by the network I/F 809 and the CPU 801 illustrated in FIG. 3 in response to execution of a program.

The information collection unit 502 is a functional unit that collects the device-related information from the image forming apparatus 10 via the communication unit 501, for example, periodically. The information collection unit 502 is implemented by, for example, the CPU 801 illustrated in FIG. 3 executing a program.

The information providing unit 503 is a functional unit that provides the device-related information related to the image forming apparatus 10 indicated by the target device information to the color adjustment assistance system 40 via the communication unit 501 in accordance with a request from the color adjustment assistance system 40. The information providing unit 503 is implemented by, for example, the CPU 801 illustrated in FIG. 3 executing a program.

The storage unit 504 is a functional unit that stores the device-related information and the like collected by the information collection unit 502. The storage unit 504 is implemented by the auxiliary storage device 805 illustrated in FIG. 3.

Of the functional units of the device management system 50 illustrated in FIG. 4, at least some of the functional units implemented by software (program) may be implemented by a hardware circuit such as an FPGA or an ASIC.

While the functional units of the device management system 50 illustrated in FIG. 4 are conceptually illustrated functions, the functional units are not limited to such a configuration. For example, two or more of the functional units of the device management system 50 illustrated as independent functional units in FIG. 4 may be integrated into a single functional unit. In contrast, a function of one functional unit in the device management system 50 illustrated in FIG. 4 may be divided into a plurality of functions and implemented as a plurality of functional units. The functional units of the device management system 50 are not necessarily implemented as distinct software modules illustrated as the blocks in FIG. 4, and the functions of the functional units may be implemented as a whole by the device management system 50 executing a program.

As illustrated in FIG. 4, the image analysis system 91 includes a communication unit 911 and an image analysis unit 912.

The communication unit 911 is a functional unit that performs data communication with the color adjustment assistance system 40. The communication unit 911 is implemented by the network I/F 809 and the CPU 801 illustrated in FIG. 3 in response to execution of a program.

The image analysis unit 912 is a functional unit that, in response to receipt of an image analysis request from the color adjustment assistance system 40 via the communication unit 911, performs image analysis on the document data and the read data of the print sample PS and the reproduced image print RIP received together with the image analysis request. The image analysis unit 912 transmits image analysis information indicating a result of the image analysis to the color adjustment assistance system 40 via the communication unit 911. The image analysis unit 912 is implemented by, for example, the CPU 801 illustrated in FIG. 3 executing a program.

The image analysis unit 912 of the image analysis system 91 illustrated in FIG. 4 may be implemented by a hardware circuit such as an FPGA or an ASIC.

While the functional units of the image analysis system 91 illustrated in FIG. 4 are conceptually illustrated functions, the functional units are not limited to such a configuration. For example, two or more of the functional units of the image analysis system 91 illustrated as independent functional units in FIG. 4 may be integrated into a single functional unit. In contrast, a function of one functional unit in the image analysis system 91 illustrated in FIG. 4 may be divided into a plurality of functions and implemented as a plurality of functional units. The functional units of the image analysis system 91 are not necessarily implemented as distinct software modules illustrated as the blocks in FIG. 4, and the functions of the functional units may be implemented as a whole by the image analysis system 91 executing a program.

As illustrated in FIG. 4, the similar case search system 92 includes a communication unit 921, a learning unit 922, a search unit 923, and a storage unit 924.

The communication unit 921 is a functional unit that performs data communication with the color adjustment assistance system 40. The communication unit 921 is implemented by the network I/F 809 and the CPU 801 illustrated in FIG. 3 in response to execution of a program.

The learning unit 922 is a functional unit that searches for a similar case related to a problem with the job color adjustment by machine learning and generates a learning model for inferring a candidate handling method. The machine learning is, for example, supervised learning, and learning data used to train the learning model includes, for example, the job information, the image analysis information, and phenomena, causes, and results extracted from the support history. The labels to be assigned to the learning data (training data) used for supervised learning include handling methods extracted from the support history and handling results for problems (such as determining whether the problems have been solved). The learning unit 922 may generate such learning data by referring to the database 93. In this case, for example, as illustrated in FIG. 9, the learning unit 922 extracts a phenomenon, a cause, a handling method, and a result from the support history stored for each job in the database 93.

The learning model is generated to output, for example, a candidate handling method, a degree of similarity between cases, and a handling result. When a plurality of candidate handling methods are found, the plurality of candidate handling methods may be output in order of priority in accordance with the degree of similarity and the handling result. For example, when the handling result indicates that the problem has been solved, the corresponding handling method may be preferentially output. The learning unit 922 stores the generated learning model in the storage unit 924.

FIG. 10 illustrates a list of causes of problems with the job color adjustment, specific examples of the problems, and examples of handling methods. The handling methods include handling methods on the assistance side (service provider side) and handling methods on the user side.

The learning unit 922 is implemented by, for example, the CPU 801 illustrated in FIG. 3 executing a program.

The search unit 923 is a functional unit that, in response to receipt of a search request from the color adjustment assistance system 40 via the communication unit 921, uses the learning model stored in the storage unit 924 to search for a similar case related to the problem with the job color adjustment by using the job information, the support history, and the image analysis information received together with the search request. Specifically, the search unit 923 extracts a phenomenon from the received support history, inputs the received job information and image analysis information and the extracted phenomenon as input data to the learning model, and acquires candidate handling methods for the problem with the job color adjustment output from the learning model. The candidate handling methods are handling methods used in previously similar cases related to the problem with the job color adjustment. Then, the search unit 923 transmits a search result including the candidate handling methods obtained from the learning model to the color adjustment assistance system 40 via the communication unit 921. The search unit 923 may output all or some of the handling methods obtained through the search. The learning model may refer to the database 93 to infer a candidate handling method. The search unit 923 is implemented by, for example, the CPU 801 illustrated in FIG. 3 executing a program.

The search unit 923 is not limited to receiving the job information, the support history, and the image analysis information together with the search request from the color adjustment assistance system 40, and may acquire the job information, the support history, and the image analysis information by referring to the information stored in the database 93 from the color adjustment assistance system 40.

The storage unit 924 is a functional unit that stores, for example, the learning model trained by the learning unit 922. The storage unit 924 is implemented by the auxiliary storage device 805 illustrated in FIG. 3.

Of the functional units of the similar case search system 92 illustrated in FIG. 4, at least some of the functional units implemented by software (program) may be implemented by a hardware circuit such as an FPGA or an ASIC.

While the functional units of the similar case search system 92 illustrated in FIG. 4 are conceptually illustrated functions, the functional units are not limited to such a configuration. For example, two or more of the functional units of the similar case search system 92 illustrated as independent functional units in FIG. 4 may be integrated into a single functional unit. In contrast, a function of one functional unit in the similar case search system 92 illustrated in FIG. 4 may be divided into a plurality of functions and implemented as a plurality of functional units. The functional units of the similar case search system 92 are not necessarily implemented as distinct software modules illustrated as the blocks in FIG. 4, and the functions of the functional units may be implemented as a whole by the similar case search system 92 executing a program.

As illustrated in FIG. 4, the service provider terminal 60 includes a communication unit 601, an input unit 602, and a display control unit 603.

The communication unit 601 is a functional unit that performs data communication with the color adjustment assistance system 40. The communication unit 601 is implemented by the network I/F 809 and the CPU 801 illustrated in FIG. 3 in response to execution of a program.

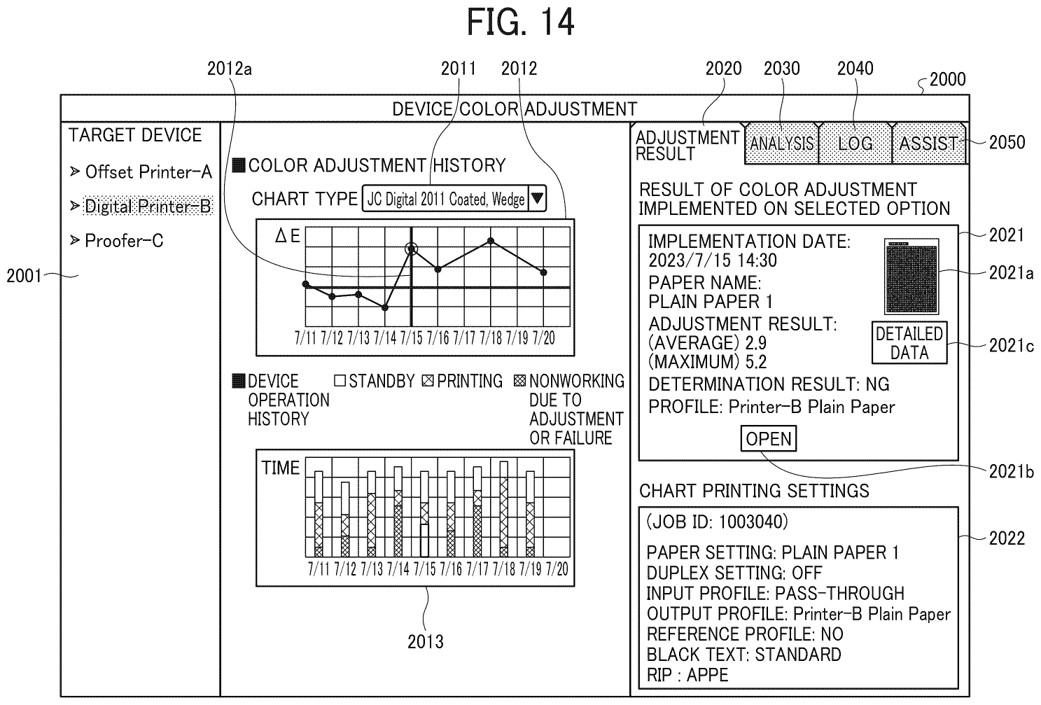

The input unit 602 is a functional unit used by the service provider to input, for example, a response to an assistance request on, for example, a device color adjustment assistance screen 2000 illustrated in FIG. 14 described below. The input unit 602 is implemented by the keyboard 811 and the mouse 812 illustrated in FIG. 3.

The display control unit 603 is a functional unit that controls the display 808 of the service provider terminal 60 to display various screens (e.g., the device color adjustment assistance screen 2000 described below) and information. The display control unit 603 is implemented by, for example, the CPU 801 illustrated in FIG. 3 executing a program.

Of the functional units of the service provider terminal 60 illustrated in FIG. 4, at least some of the functional units implemented by software (program) may be implemented by a hardware circuit such as an FPGA or an ASIC.

While the functional units of the service provider terminal 60 illustrated in FIG. 4 are conceptually illustrated functions, the functional units are not limited to such a configuration. For example, two or more of the functional units of the service provider terminal 60 illustrated as independent functional units in FIG. 4 may be integrated into a single functional unit. In contrast, a function of one functional unit in the service provider terminal 60 illustrated in FIG. 4 may be divided into a plurality of functions and implemented as a plurality of functional units. The functional units of the service provider terminal 60 are not necessarily implemented as distinct software modules illustrated as the blocks in FIG. 4, and the functions of the functional units may be implemented as a whole by the service provider terminal 60 executing a program.

The functional units included in the image forming apparatus 10, the color adjustment system 20, the color adjustment assistance system 40, the device management system 50, the image analysis system 91, the similar case search system 92, and the service provider terminal 60 illustrated in FIG. 4 are not limited to being included in their respective apparatuses and may be included in other apparatuses.

### Screens Displayed by Print Service Provider

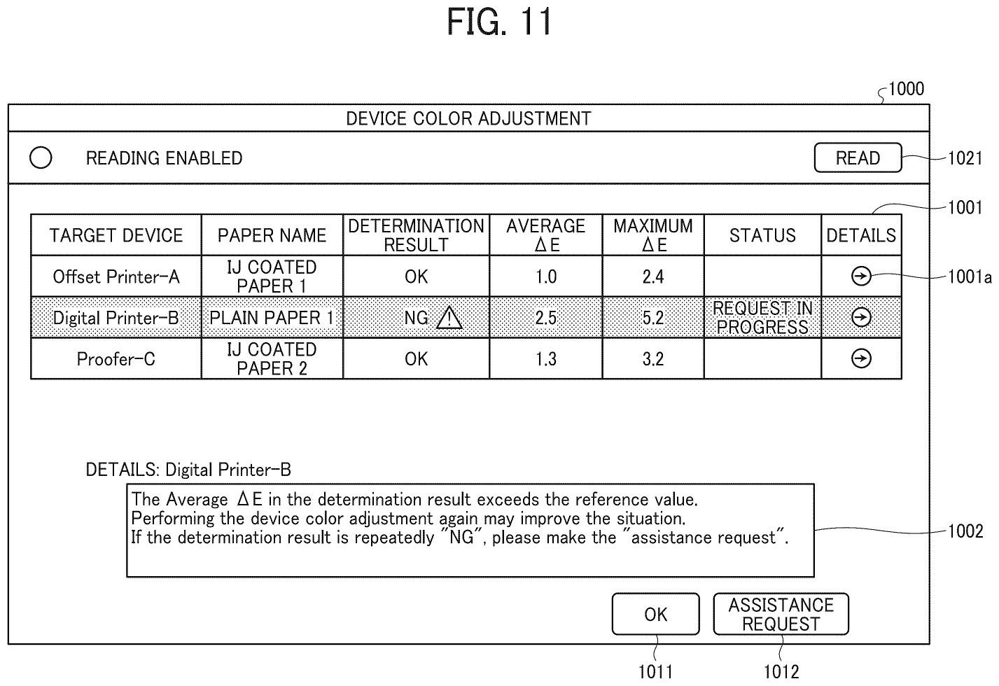

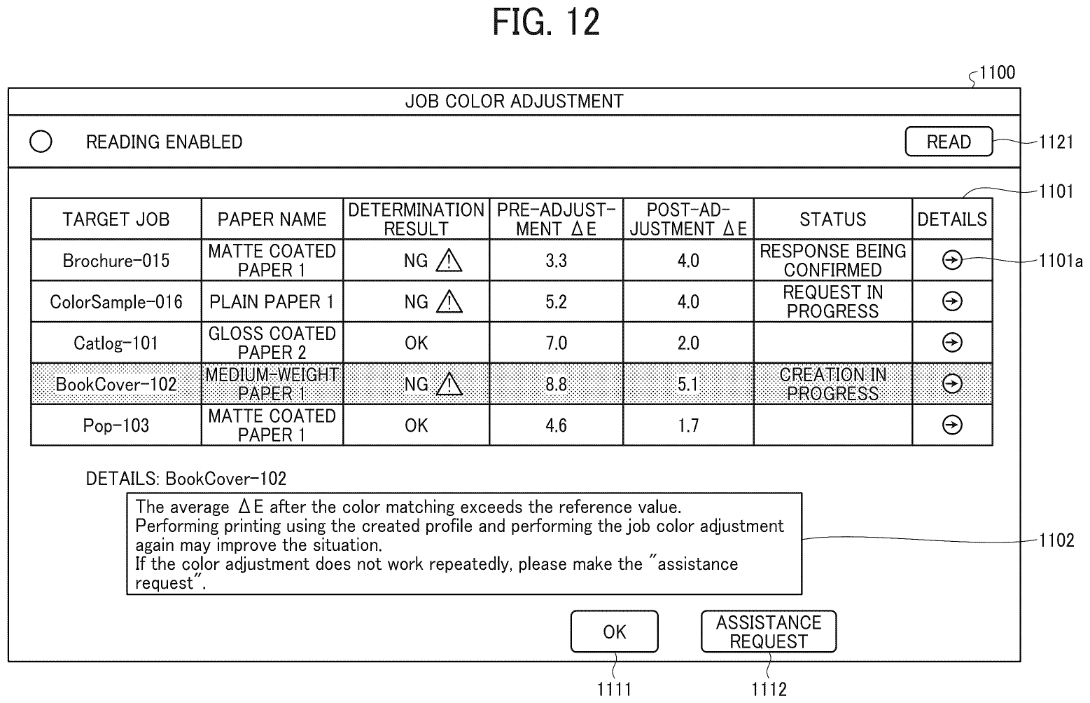

FIG. 11 is a diagram illustrating an example of a device color adjustment result screen displayed by the print service provider. FIG. 12 is a diagram illustrating an example of a job color adjustment result screen displayed by the print service provider. FIG. 13 is a diagram illustrating an example of an assistance request screen displayed by the print service provider. The screens displayed by the print service provider (i.e., the color adjustment system 20) in the information processing system 1 will be described with reference to FIGS. 11 to 13.

When the print service provider, or the user, performs an operation to display the device color adjustment result screen 1000 as illustrated in FIG. 11 through the input unit 208 of the color adjustment system 20, the display control unit 209 transmits a request to display the device color adjustment result screen 1000 to the color adjustment assistance system 40 via the communication unit 201. In response to the request, the UI unit 402 of the color adjustment assistance system 40 transmits screen information of the device color adjustment result screen 1000 to the color adjustment system 20 via the communication unit 401. Along with the transmission of the screen information from the UI unit 402, the information transmission unit 404 transmits adjustment-related information and device-related information to be used to display the device color adjustment result screen 1000 to the color adjustment system 20. Then, the display control unit 209 causes the display 808 to display the device color adjustment result screen 1000.

The device color adjustment result screen 1000 is a screen that displays a history of determination results obtained in the device color adjustment performed by the color adjustment system 20. As illustrated in FIG. 11, the device color adjustment result screen 1000 includes a color adjustment result display area 1001, a details display area 1002, an OK button 1011, an assistance request button 1012, and a read button 1021.

The color adjustment result display area 1001 is an area that displays a determination result of the device color adjustment for each target device (the image forming apparatus 10). In the example illustrated in FIG. 11, the color adjustment result display area 1001 displays a target device (the image forming apparatus 10), a paper name, a determination result, an average ΔE, a maximum ΔE, and a status in association with each other. In a “details” field of the color adjustment result display area 1001, a details button 1001a is arranged for each target device. When the details button 1001a is pressed, the display control unit 209 makes the row of the corresponding target device highlighted and displays the details of the determination result in the details display area 1002. Examples of the status include “creation in progress” indicating that a comment such as a question to the service provider about the “NG” result of the determination of the device color adjustment is being created, “request in progress” indicating that an assistance request is made on the assistance request screen 1200 described below, and “response being confirmed” indicating a state in which a response to the assistance request has been received from the service provider and can be confirmed.

As described above, the details display area 1002 is an area that displays the details of the determination result of the device color adjustment performed on the target device for which the details button 1001a is pressed.

The OK button 1011 is a button for closing the device color adjustment result screen 1000. The assistance request button 1012 is a button for displaying the assistance request screen 1200 illustrated in FIG. 13 to make an assistance request for a target device for which the determination result is “NG” among the target devices displayed in the color adjustment result display area 1001.

The read button 1021 is a button for causing the image reading device 30 to read again, for example, the color chart corresponding to the target device highlighted in the color adjustment result display area 1001.

When the print service provider, or the user, performs an operation to display a job color adjustment result screen 1100 as illustrated in FIG. 12 through the input unit 208 of the color adjustment system 20, the display control unit 209 transmits a request to display the job color adjustment result screen 1100 to the color adjustment assistance system 40 via the communication unit 201. In response to the request, the UI unit 402 of the color adjustment assistance system 40 transmits screen information of the job color adjustment result screen 1100 to the color adjustment system 20 via the communication unit 401. Along with the transmission of the screen information from the UI unit 402, the information transmission unit 404 transmits adjustment-related information and device-related information to be used to display the job color adjustment result screen 1100 to the color adjustment system 20. Then, the display control unit 209 causes the display 808 to display the job color adjustment result screen 1100.

The job color adjustment result screen 1100 is a screen that displays a history of determination results obtained in the job color adjustment performed by the color adjustment system 20. As illustrated in FIG. 12, the job color adjustment result screen 1100 includes a color adjustment result display area 1101, a details display area 1102, an OK button 1111, an assistance request button 1112, and a read button 1121.

The color adjustment result display area 1101 is an area that displays a determination result of the job color adjustment for each target job (job for document data). In the example illustrated in FIG. 12, the color adjustment result display area 1101 displays a target job (job for document data), a paper name, a determination result, a pre-adjustment ΔE, a post-adjustment ΔE, and a status in association with each other. In a “details” field of the color adjustment result display area 1101, a details button 1101a is arranged for each target job. When the details button 1101a is pressed, the display control unit 209 makes the row of the corresponding target job highlighted and displays the details of the determination result in the details display area 1102. Examples of the status include “creation in progress” indicating that a comment such as a question to the service provider about the “NG” result of the determination of the job color adjustment is being created, “request in progress” indicating that an assistance request is made on the assistance request screen 1200 described below, and “response being confirmed” indicating a state in which a response to the assistance request has been received from the service provider and can be confirmed.

As described above, the details display area 1102 is an area that displays the details of the determination result of the job color adjustment performed on the target job for which the details button 1101a is pressed.

The OK button 1111 is a button for closing the job color adjustment result screen 1100. The assistance request button 1112 is a button for displaying the assistance request screen 1200 illustrated in FIG. 13 to make an assistance request for a target job for which the determination result is “NG” among the target jobs displayed in the color adjustment result display area 1101.

The read button 1121 is a button for causing the image reading device 30 to read again, for example, the print sample or the reproduced image print corresponding to the target job highlighted in the color adjustment result display area 1101.

When the print service provider, or the user, presses the assistance request button 1012 on the device color adjustment result screen 1000 or the assistance request button 1112 on the job color adjustment result screen 1100 through the input unit 208 of the color adjustment system 20, the display control unit 209 transmits a request to display the assistance request screen 1200 to the color adjustment assistance system 40 via the communication unit 201. In response to the request, the UI unit 402 of the color adjustment assistance system 40 transmits screen information of the assistance request screen 1200 to the color adjustment system 20 via the communication unit 401. Along with the transmission of the screen information from the UI unit 402, the information transmission unit 404 transmits adjustment-related information and device-related information to be used to display the assistance request screen 1200 to the color adjustment system 20. Then, the display control unit 209 causes the display 808 to display the assistance request screen 1200.

The assistance request screen 1200 is a screen for making an assistance request to the color adjustment assistance system 40 for the target device and the target job for which the determination result of the device color adjustment and the job color adjustment is “NG”. As illustrated in FIG. 13, the assistance request screen 1200 includes a job color adjustment result display area 1201, a device color adjustment result display area 1202, a comment input area 1211, a file attachment button 1212, an attached file display area 1213, a history display area 1221, and a submit button 1231.

The job color adjustment result display area 1201 is an area that displays the “NG” result of the determination of the job color adjustment for each target job (job for document data). In the example illustrated in FIG. 13, the job color adjustment result display area 1201 displays a target job (job for document data), a paper name, a determination result, a pre-adjustment ΔE, a post-adjustment ΔE, and a status in association with each other. In the job color adjustment result display area 1201, a desired target job can be highlighted.

The device color adjustment result display area 1202 is an area that displays the “NG” result of the determination of the device color adjustment for each target device (the image forming apparatus 10). In the example illustrated in FIG. 13, the device color adjustment result display area 1202 displays a target device (the image forming apparatus 10), a paper name, a determination result, an average ΔE, a maximum ΔE, and a status in association with each other. In the device color adjustment result display area 1202, a desired target device can be highlighted.

As described above, by checking the content displayed in the job color adjustment result display area 1201 and the device color adjustment result display area 1202, the user can grasp a list of target jobs and target devices for which the result of the color adjustment determination is “NG”, and can check a status indicating the progress of two-way communication with the service provider for each of such target jobs and target devices about the “NG” result.

The comment input area 1211 is an area for the user to input a comment such as a question to the service provider when the user makes an assistance request to the color adjustment assistance system 40 for the target job or the target device selected in the job color adjustment result display area 1201 or the device color adjustment result display area 1202. For example, when a comment is input to the comment input area 1211, the status of the selected target job or target device is changed to “creation in progress”.

The file attachment button 1212 is a button for selecting an attached file to be transmitted when the user makes an assistance request to the color adjustment assistance system 40 for the target job or the target device selected in the job color adjustment result display area 1201 or the device color adjustment result display area 1202. Examples of the attached file include data of the profiles generated by the color adjustment system 20, document data to be subjected to the job color adjustment, data of a color chart used in the device color adjustment, and read data of the color chart.

The attached file display area 1213 is an area that displays the file name of an attached file selected by the operation of the file attachment button 1212.

The history display area 1221 is an area that displays a history (i.e., support history) of user comments input in the comment input area 1211 and transmitted to the color adjustment assistance system 40 as assistance requests, and responses (e.g., guidance and comments) received from the service provider via the color adjustment assistance system 40 in response to the assistance requests. By checking the history displayed in the history display area 1221, the user can grasp a history of previous two-way communication sessions with the service provider and easily solve a problem with color adjustment.

The submit button 1231 is a button for transmitting the comment input in the comment input area 1211 and the attached file that has been attached by the operation of the file attachment button 1212 to the color adjustment assistance system 40 together with the assistance request. In response to the pressing of the submit button 1231, the color adjustment information transmission unit 207 transmits the assistance request and adjustment-related information, namely, the comment input in the comment input area 1211 and the attached file that has been attached by the operation of the file attachment button 1212, to the color adjustment assistance system 40 via the communication unit 201. That is, the two-way communication sessions described above can involve transmission of a comment and transmission of an attached file prepared by the user, such as the profiles, the document data, or the read data of the color chart, and facilitate solving a problem with color adjustment. The color adjustment information transmission unit 207 may transmit, along with the information described above, information on the image forming apparatus 10 to be subjected to the target color adjustment (target device information) and a history of the color adjustment performed on the image forming apparatus 10 by the color adjustment system 20, as adjustment-related information, to the color adjustment assistance system 40.

### Screens Displayed by Service Provider

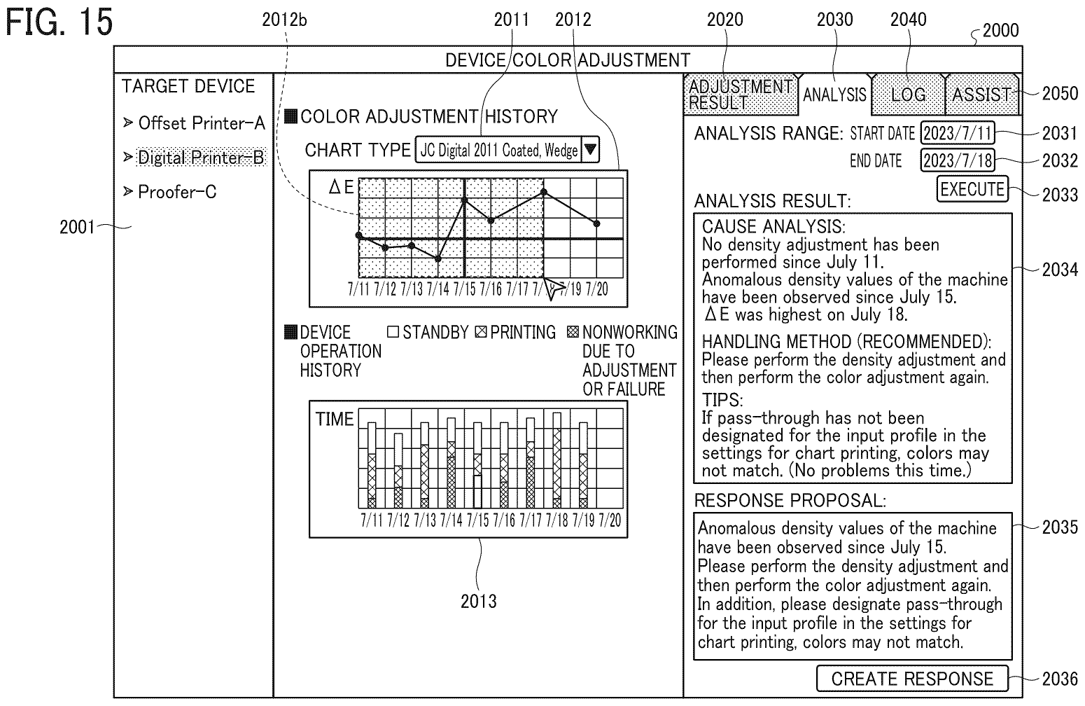

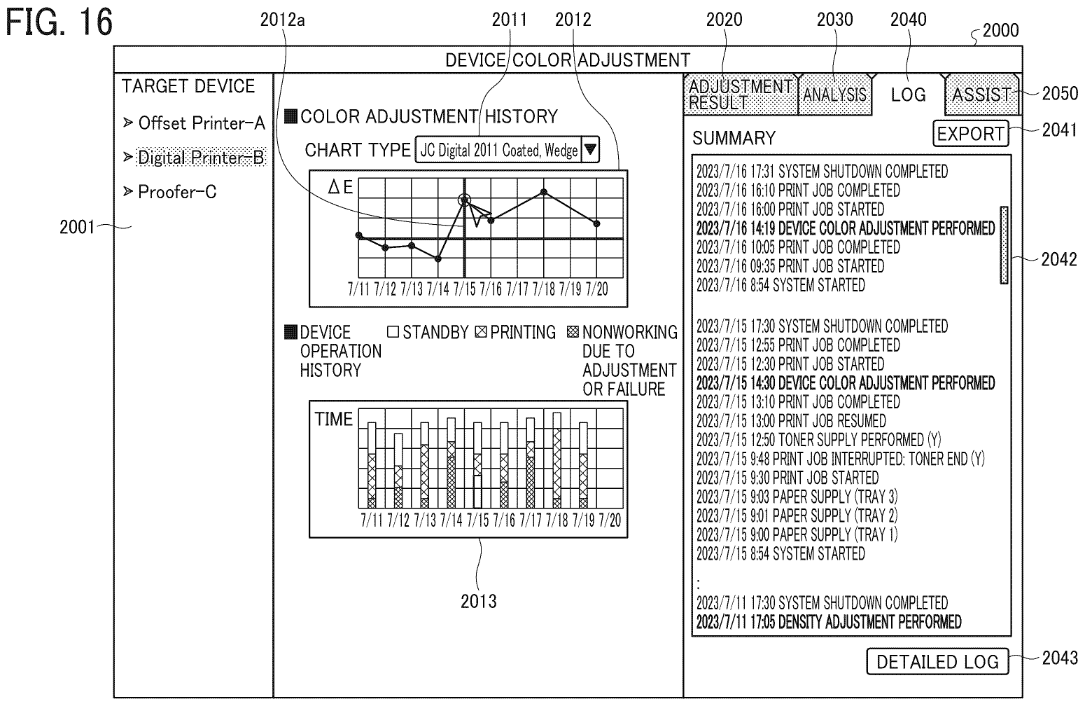

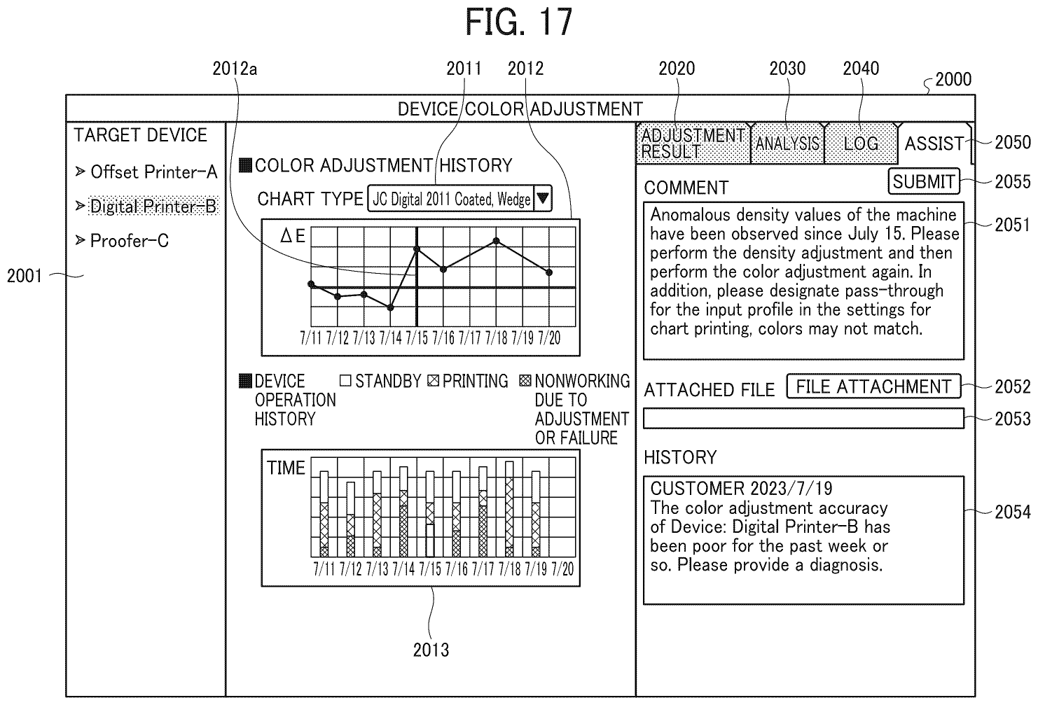

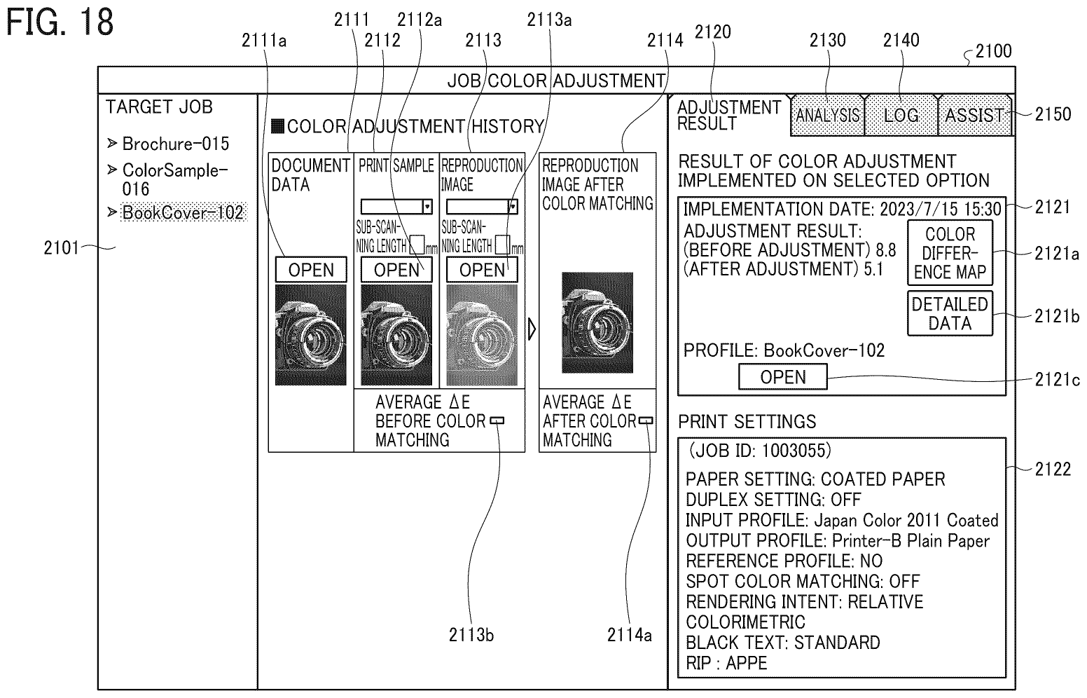

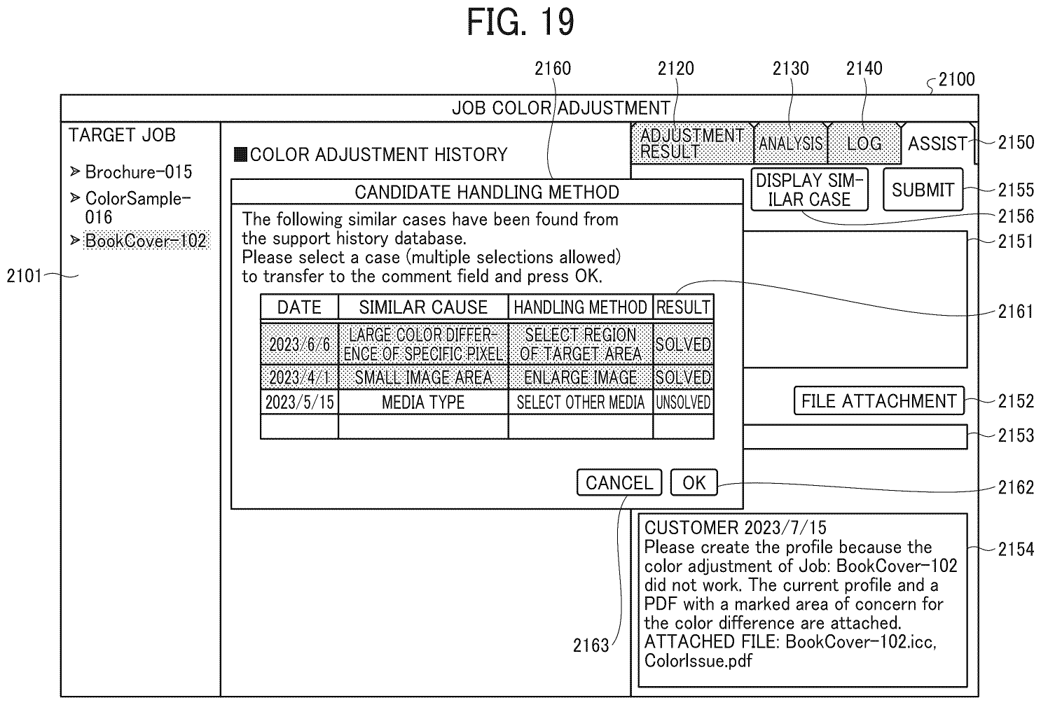

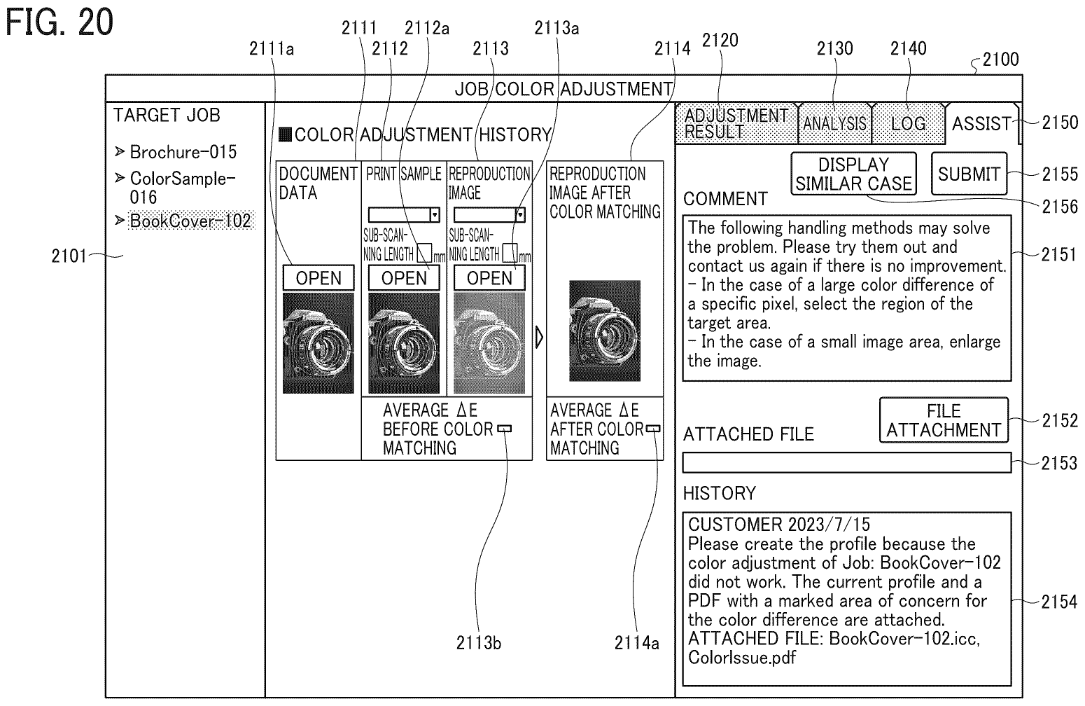

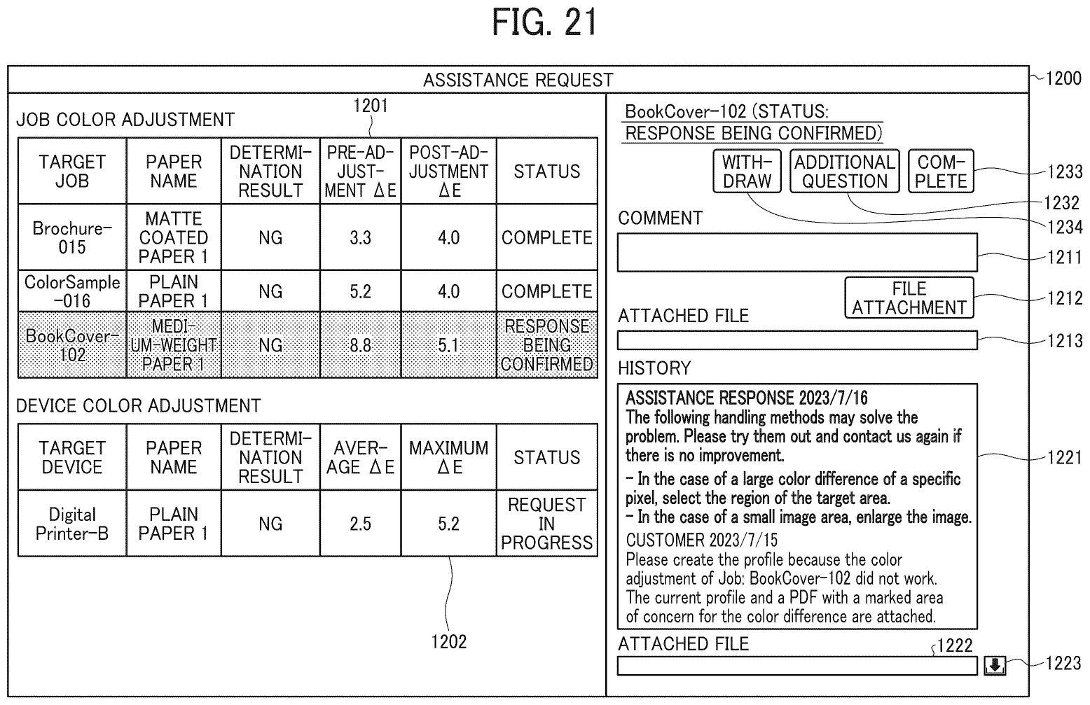

FIG. 14 is a diagram illustrating an example of a device color adjustment assistance screen (adjustment result tab) displayed by the service provider. FIG. 15 is a diagram illustrating an example of a device color adjustment assistance screen (analysis tab) displayed by the service provider. FIG. 16 is a diagram illustrating an example of a device color adjustment assistance screen (log tab) displayed by the service provider. FIG. 17 is a diagram illustrating an example of a device color adjustment assistance screen (assist tab) displayed by the service provider. FIG. 18 is a diagram illustrating an example of a job color adjustment assistance screen (adjustment result tab) displayed by the service provider. FIG. 19 is a diagram illustrating an example of a screen displayed in response to the pressing of the assist tab on the job color adjustment assistance screen displayed by the service provider. FIG. 20 is a diagram illustrating an example of a job color adjustment assistance screen (assist tab) displayed by the service provider. FIG. 21 is a diagram illustrating an example of an assistance request screen displayed in response to a receipt of a response from the service provider. The screens displayed by the service provider (the service provider terminal 60) in the information processing system 1 will be described with reference to FIGS. 14 to 20. An operation of displaying a response made by the service provider terminal 60 on a screen on the print service provider side will be described with reference to FIG. 21.

When the service provider performs an operation to display the device color adjustment assistance screen 2000 as illustrated in FIG. 14 through the input unit 602 of the service provider terminal 60, the display control unit 603 transmits a request to display the device color adjustment assistance screen 2000 to the color adjustment assistance system 40 via the communication unit 601. In response to the request, the UI unit 402 of the color adjustment assistance system 40 transmits screen information of the device color adjustment assistance screen 2000 to the service provider terminal 60 via the communication unit 401. Along with the transmission of the screen information from the UI unit 402, the information transmission unit 404 transmits adjustment-related information and device-related information to be used to display the device color adjustment assistance screen 2000 to the service provider terminal 60. Then, the display control unit 603 causes the display 808 to display the device color adjustment assistance screen 2000 reflecting the adjustment-related information and the device-related information. Accordingly, the service provider can promptly use the adjustment-related information and the device-related information as reference information to solve the problem with color adjustment in response to receipt of an assistance request.

The device color adjustment assistance screen 2000 is a screen for displaying a history of determination results in the device color adjustment performed by the color adjustment system 20, the operating status of the target device, a comment related to the assistance request from the color adjustment system 20, and the like and for allowing the service provider to input a response considered to be appropriate in response to the assistance request. That is, the device color adjustment assistance screen 2000 is a screen that displays information for assisting in solving a problem related to the device color adjustment. As illustrated in FIG. 14, the device color adjustment assistance screen 2000 includes a device selection area 2001, a color chart selection area 2011, a color adjustment history display area 2012, an operation history display area 2013, an adjustment result tab 2020, an analysis tab 2030, a log tab 2040, and an assist tab 2050. The device color adjustment assistance screen 2000 illustrated in FIG. 14 indicates a state in which the adjustment result tab 2020 is selected.

The device selection area 2001 is an area that displays a list of target devices to select a target device for which information based on the adjustment-related information and the device-related information is to be displayed in the color adjustment history display area 2012, the operation history display area 2013, the adjustment result tab 2020, the analysis tab 2030, the log tab 2040, and the assist tab 2050.

The color chart selection area 2011 is an area for selecting a color chart corresponding to a device color adjustment history to be displayed in the color adjustment history display area 2012. The color adjustment history display area 2012 is an area that displays a device color adjustment history included in the adjustment-related information transmitted from the information transmission unit 404 and corresponding to the color chart selected in the color chart selection area 2011. In the color adjustment history display area 2012 illustrated in FIG. 14, a time-series graph of a color difference ΔE (average ΔE or maximum ΔE) is displayed as the device color adjustment history. A desired color difference ΔE can be selected from the graph displayed in the color adjustment history display area 2012, and the selected color difference ΔE is indicated using a current selection object 2012a.

The operation history display area 2013 is an area that displays an operating status (“device operation history”) included in the device-related information transmitted from the information transmission unit 404 and corresponding to the target device selected in the device selection area 2001.

The adjustment result tab 2020 is a tab for displaying details of the result of the device color adjustment corresponding to the color difference ΔE selected using the current selection object 2012a. The adjustment result tab 2020 is selected to display a screen area that includes a color adjustment result display area 2021 and a print settings display area 2022. The color adjustment result display area 2021 includes a color chart display area 2021a, a file button 2021b, and a detailed data button 2021c.

The color chart display area 2021a is an area that displays an image of read data of a color chart used for the device color adjustment. The file button 2021b is a button for opening the output profile generated during the device color adjustment. The detailed data button 2021c is a button for displaying detailed data related to the device color adjustment.

The print settings display area 2022 is an area that displays print settings information used to print the color chart used for the device color adjustment corresponding to the color difference ΔE selected using the current selection object 2012a.

The analysis tab 2030 is a tab for displaying, for example, an analysis result of the device color adjustment for the target device selected in the device selection area 2001. The log tab 2040 is a tab for displaying various logs related to the target device selected in the device selection area 2001. The assist tab 2050 is a tab for displaying an area for the service provider to input a response to the assistance request for the target device selected in the device selection area 2001.

When the service provider performs an operation to select the analysis tab 2030 through the input unit 602 of the service provider terminal 60, the display control unit 603 causes the display 808 to display a device color adjustment assistance screen 2000 illustrated in FIG. 15. That is, the device color adjustment assistance screen 2000 illustrated in FIG. 15 indicates a state in which the analysis tab 2030 is selected.

The analysis tab 2030 is selected to display a screen area that includes a start date input area 2031, an end date input area 2032, an execute button 2033, an analysis result display area 2034, a response proposal display area 2035, and a response creation button 2036.

The start date input area 2031 is an area for inputting a start date of a period over which the analysis is to be performed by the analysis unit 405, based on the graph of the device color adjustment displayed in the color adjustment history display area 2012. The end date input area 2032 is an area for inputting an end date of the period over which the analysis is to be performed by the analysis unit 405, based on the graph of the device color adjustment displayed in the color adjustment history display area 2012. While the service provider enters dates in the start date input area 2031 and the end date input area 2032 to designate the period over which the analysis is to be performed by the analysis unit 405, as illustrated in FIG. 15, the service provider may select a selection area 2012b by, for example, dragging over the graph displayed in the color adjustment history display area 2012 by using the input unit 602 to designate the period over which the analysis is to be performed. The display control unit 603 may generate a file of an image obtained by converting the graph in the color adjustment history display area 2012 specified by the selection area 2012b into a bitmap, and store the file in the service provider terminal 60 or the color adjustment assistance system 40 (the storage unit 408).

The execute button 2033 is a button for requesting the color adjustment assistance system 40 to perform analysis using the device color adjustment history information corresponding to the period designated by using the start date input area 2031 and the end date input area 2032 (or the period designated by using the selection area 2012b). When the execute button 2033 is pressed and an analysis request and the history information of the period are transmitted to the color adjustment assistance system 40, the analysis unit 405 of the color adjustment assistance system 40 analyzes the problem with the device color adjustment by using the history information, automatically generates a comment indicating the analysis result, and displays the comment in the analysis result display area 2034. The analysis unit 405 also automatically generates a comment indicating a response proposal for the user (print service provider) and displays the comment in the response proposal display area 2035.

The response creation button 2036 is a button for transferring the comment indicating the response proposal displayed in the response proposal display area 2035 to a comment input area 2051 in the assist tab 2050 illustrated in FIG. 17 described below. Accordingly, by editing the transferred comment in the comment input area 2051 described below, which is displayed in response to selecting the assist tab 2050, the service provider can easily create a comment without creating a response comment from the beginning.

When the service provider performs an operation to select the log tab 2040 through the input unit 602 of the service provider terminal 60, the display control unit 603 causes the display 808 to display a device color adjustment assistance screen 2000 illustrated in FIG. 16. That is, the device color adjustment assistance screen 2000 illustrated in FIG. 16 indicates a state in which the log tab 2040 is selected.

The log tab 2040 is selected to display a screen area that includes an export button 2041, a log display area 2042, and a detailed log button 2043.

The export button 2041 is a button for exporting a target-device log displayed in the log display area 2042 to a file. The log display area 2042 is an area that displays a log based on the device-related information (the operating status and the error history) and the adjustment-related information (the device color adjustment history and the operation history) transmitted from the information transmission unit 404. The detailed log button 2043 is a button for displaying the details of the log.

When the service provider performs an operation to select the assist tab 2050 through the input unit 602 of the service provider terminal 60, the display control unit 603 causes the display 808 to display a device color adjustment assistance screen 2000 illustrated in FIG. 17. That is, the device color adjustment assistance screen 2000 illustrated in FIG. 17 indicates a state in which the assist tab 2050 is selected.

The assist tab 2050 is selected to display a screen area that includes the comment input area 2051, a file attachment button 2052, an attached file display area 2053, a history display area 2054, and a submit button 2055.

The comment input area 2051 is an area for the service provider to input a comment in response to the assistance request from the color adjustment system 20, by performing an operation input through the input unit 602. The comment indicates, for example, countermeasures and guidance for the “NG” result of the determination of the device color adjustment for the target device selected in the device selection area 2001. Examples of the comment include a comment prompting device color adjustment to address a problem with the maintenance of the image forming apparatus 10, and a comment indicating a method for creating a profile if the profile has a problem. As described above, in response to the pressing of the response creation button 2036, the comment indicating the response proposal displayed in the response proposal display area 2035 is transferred to the comment input area 2051. In this case, the service provider can edit the comment or add information to the comment in the comment input area 2051, by performing an operation input through the input unit 602.

The file attachment button 2052 is a button for selecting an attached file, such as a profile created by the service provider, as a response to the assistance request from the color adjustment system 20. That is, if the profile has a problem, the service provider can create an appropriate profile or the like and respond to the problem by providing the created profile as an attached file. The service provider may operate the file attachment button 2052 to select, as an attached file, the bitmap file generated through selection based on the selection area 2012b described above. With the bitmap file, the service provider can specifically present, to the user, information indicating the cause of the problem with color adjustment, making it easier for the user to solve the problem with color adjustment.

The attached file display area 2053 is an area that displays the file name of an attached file selected by the operation of the file attachment button 2052.

The history display area 2054 is an area that displays a history of a service provider comment input in the comment input area 2051 and transmitted to the color adjustment system 20 as a response to the assistance request, and a comment (such as a question) received in relation to the assistance request from the print service provider via the color adjustment system 20. By checking the history displayed in the history display area 2054, the service provider can grasp a history of previous two-way communication sessions with the print service provider and easily provide an appropriate response to solve the problem with color adjustment.

The submit button 2055 is a button for transmitting the service provider comment displayed in the comment input area 2051 and the attached file that has been attached by the operation of the file attachment button 2052 to the color adjustment system 20 via the color adjustment assistance system 40 as a response to the assistance request. In response to the pressing of the submit button 2055, the communication unit 601 transmits the service provider comment displayed in the comment input area 2051 and the attached file that has been attached by the operation of the file attachment button 2052 to the color adjustment assistance system 40 as a response to the assistance request, and the response acquisition unit 406 of the color adjustment assistance system 40 acquires the comment and the attached file. That is, the two-way communication sessions described above can involve transmission of a comment and transmission of an attached file prepared and adjusted by the service provider, such as the profiles or the document data, and facilitate solving the problem with color adjustment. Then, the information notification unit 407 of the color adjustment assistance system 40 notifies the color adjustment system 20 of the response acquired by the response acquisition unit 406 via the communication unit 401.

When the service provider performs an operation to display a job color adjustment assistance screen 2100 (an example of an assistance screen) as illustrated in FIG. 18 through the input unit 602 of the service provider terminal 60, the display control unit 603 transmits a request to display the job color adjustment assistance screen 2100 to the color adjustment assistance system 40 via the communication unit 601. In response to the request, the UI unit 402 of the color adjustment assistance system 40 transmits screen information of the job color adjustment assistance screen 2100 to the service provider terminal 60 via the communication unit 401. Along with the transmission of the screen information from the UI unit 402, the information transmission unit 404 transmits adjustment-related information and device-related information to be used to display the job color adjustment assistance screen 2100 to the service provider terminal 60. Then, the display control unit 603 causes the display 808 to display the job color adjustment assistance screen 2100 reflecting the adjustment-related information and the device-related information. Accordingly, the service provider can promptly use the adjustment-related information and the device-related information as reference information to solve the problem with color adjustment in response to receipt of an assistance request.

The job color adjustment assistance screen 2100 is a screen for displaying a history of determination results in the job color adjustment performed by the color adjustment system 20, a comment related to the assistance request from the color adjustment system 20, and the like and for allowing the service provider to input a response considered to be appropriate in response to the assistance request. That is, the job color adjustment assistance screen 2100 is a screen that displays information for assisting in solving a problem related to the job color adjustment. As illustrated in FIG. 18, the job color adjustment assistance screen 2100 includes a job selection area 2101, a document data display area 2111, a print sample display area 2112, a reproduction screen display area 2113, a pre-color-matching average color difference display area 2113b, a post-color-matching reproduction image display area 2114, an adjustment result tab 2120, an analysis tab 2130, a log tab 2140, and an assist tab 2150. The job color adjustment assistance screen 2100 illustrated in FIG. 18 indicates a state in which the adjustment result tab 2120 is selected.

The job selection area 2101 is an area that displays a list of target jobs to select a target job for which information based on the adjustment-related information and the device-related information is to be displayed in the document data display area 2111, the print sample display area 2112, the reproduction screen display area 2113, the pre-color-matching average color difference display area 2113b, the post-color-matching reproduction image display area 2114, the adjustment result tab 2120, the analysis tab 2130, the log tab 2140, and the assist tab 2150.

The document data display area 2111 is an area that displays an image of document data of a target job selected in the job selection area 2101, and includes an open button 2111a. The open button 2111a is a button for opening the document data.

The print sample display area 2112 is an area that displays an image of a print sample corresponding to the target job selected in the job selection area 2101. The image of the print sample is based on the read data of the print sample. The print sample display area 2112 includes an open button 2112a. The open button 2112a is a button for opening the read data of the print sample.

The reproduction screen display area 2113 is an area that displays a reproduction image based on the read data of the reproduced image print corresponding to the target job selected in the job selection area 2101, and includes an open button 2113a. The reproduction screen display area 2113 may be referred to the reproduction image display area. The open button 2113a is a button for opening the read data of the reproduced image print.

The pre-color-matching average color difference display area 2113b is an area that displays the pre-adjustment ΔE for the target job selected in the job selection area 2101.

The post-color-matching reproduction image display area 2114 is an area that displays an image (color-matched reproduction image) obtained by performing color matching on the reproduction image displayed in the reproduction screen display area 2113 for the target job selected in the job selection area 2101, and includes a post-color-matching average color difference display area 2114a. The post-color-matching average color difference display area 2114a is an area that displays the post-adjustment ΔE for the target job selected in the job selection area 2101.

The adjustment result tab 2120 is a tab for displaying details of the result of the job color adjustment corresponding to the target job selected in the job selection area 2101. The adjustment result tab 2120 is selected to display a screen area that includes a color adjustment result display area 2121 and a print settings display area 2122. The color adjustment result display area 2121 includes a color difference map button 2121a, a detailed data button 2121b, and a file button 2121c.

The color difference map button 2121a is a button for displaying a color difference map generated during the job color adjustment corresponding to the target job selected in the job selection area 2101. The detailed data button 2121b is a button for displaying detailed data related to the job color adjustment. The file button 2121c is a button for opening an input profile generated during the job color adjustment.

The print settings display area 2122 is an area that displays print settings information used to print the document data of the target job selected in the job selection area 2101.

The analysis tab 2130 is a tab for displaying, for example, an analysis result of the job color adjustment for the target job selected in the job selection area 2101. The log tab 2140 is a tab for displaying various logs related to the target job selected in the job selection area 2101. The assist tab 2150 is a tab for displaying an area for the service provider to input a response to the assistance request for the target job selected in the job selection area 2101.

When the service provider performs an operation to select the assist tab 2150 through the input unit 602 of the service provider terminal 60, the display control unit 603 causes the display 808 to display a job color adjustment assistance screen 2100 illustrated in FIG. 19. That is, the job color adjustment assistance screen 2100 illustrated in FIG. 19 indicates a state in which the assist tab 2150 is selected. When the assist tab 2150 is selected, as illustrated in FIG. 19, the display control unit 603 automatically displays a candidate handling method dialog box 2160 on the job color adjustment assistance screen 2100.

The candidate handling method dialog box 2160 is a screen that displays candidate handling methods for the problem related to the job color adjustment for the target job selected in the job selection area 2101. As illustrated in FIG. 19, the candidate handling method dialog box 2160 includes a candidate handling method display area 2161, an OK button 2162, and a cancel button 2163.

As described above, the candidate handling method display area 2161 is an area that displays candidate handling methods found by the learning model of the similar case search system 92 in response to a search request from the search request unit 411 of the color adjustment assistance system 40 to the similar case search system 92. In the candidate handling method display area 2161, for each of the candidate handling methods, a date, a cause of the problem with the job color adjustment for the similar case, and a handling result are displayed in association with each other. One or more candidate handling methods can be selected by pressing the candidate handling methods in the candidate handling method display area 2161.

The OK button 2162 is a button for displaying a comment indicating the handling methods corresponding to the candidate handling methods selected in the candidate handling method display area 2161. In response to the pressing of the OK button 2162, the analysis unit 405 of the color adjustment assistance system 40 automatically generates a comment indicating the handling methods corresponding to the candidate handling methods selected in the candidate handling method display area 2161, and the display control unit 603 displays the comment in a comment input area 2151 described below. In this case, the display control unit 603 hides the candidate handling method dialog box 2160.

The cancel button 2163 is a button for hiding the candidate handling method dialog box 2160 without causing the analysis unit 405 to automatically generate a comment.

A job color adjustment assistance screen 2100 illustrated in FIG. 20 indicates a state after the OK button 2162 has been pressed in the candidate handling method dialog box 2160 illustrated in FIG. 19. The assist tab 2150 is selected to display a screen area that includes the comment input area 2151, a file attachment button 2152, an attached file display area 2153, a history display area 2154, a submit button 2155, and a similar case display button 2156.

The comment input area 2151 is an area for the service provider to input a comment in response to the assistance request from the color adjustment system 20, by performing an operation input through the input unit 602. The comment indicates, for example, countermeasures and guidance for the “NG” result of the determination of the job color adjustment for the target job selected in the job selection area 2101. Examples of the comment include a comment indicating a method for creating a profile if the profile has a problem, and a comment providing guidance on a method for adjusting document data or print settings if the document data has a problem. As described above, in the comment input area 2151, a comment indicating a handling method corresponding to a candidate handling method selected in the candidate handling method dialog box 2160 is automatically displayed. In this case, the service provider can edit the comment or add information to the comment in the comment input area 2151, by performing an operation input through the input unit 602.

The file attachment button 2152 is a button for selecting an attached file, such as a profile created by the service provider or document data adjusted by the service provider, as a response to the assistance request from the color adjustment system 20. That is, if the profile or the document data has a problem, the service provider can create an appropriate profile or adjust the document data and respond to the problem by providing the created profile or the adjusted document data as an attached file.

The attached file display area 2153 is an area that displays the file name of an attached file selected by the operation of the file attachment button 2152.

The history display area 2154 is an area that displays a history of a service provider comment input in the comment input area 2151 and transmitted to the color adjustment system 20 as a response to the assistance request, and a comment (such as a question) received in relation to the assistance request from the print service provider via the color adjustment system 20. By checking the history displayed in the history display area 2154, the service provider can grasp a history of previous two-way communication sessions with the print service provider and easily provide an appropriate response to solve the problem with color adjustment.

The similar case display button 2156 is a button for displaying the candidate handling method dialog box 2160 illustrated in FIG. 19. When the similar case display button 2156 is pressed, the display control unit 603 displays the candidate handling method dialog box 2160.

The submit button 2155 is a button for transmitting the service provider comment displayed in the comment input area 2151 and the attached file that has been attached by the operation of the file attachment button 2152 to the color adjustment system 20 via the color adjustment assistance system 40 as a response to the assistance request. In response to the pressing of the submit button 2155, the communication unit 601 transmits the service provider comment displayed in the comment input area 2151 and the attached file that has been attached by the operation of the file attachment button 2152 to the color adjustment assistance system 40 as a response to the assistance request, and the response acquisition unit 406 of the color adjustment assistance system 40 acquires the comment and the attached file. Then, the information notification unit 407 of the color adjustment assistance system 40 notifies the color adjustment system 20 of the response acquired by the response acquisition unit 406 via the communication unit 401. As a result, as illustrated in FIG. 21, the content of the response sent from the information notification unit 407 is displayed as a history on the assistance request screen 1200 displayed by the color adjustment system 20. Further, the information notification unit 407 causes the handling method indicated by the service provider comment displayed in the comment input area 2151, which is acquired by the response acquisition unit 406, to be stored in the database 93 in association with a job corresponding to the handling method. The handling method indicated by the service provider comment displayed in the comment input area 2151 may be a candidate handling method selected in the candidate handling method display area 2161.

The example of the assistance request screen 1200 illustrated in FIG. 21 indicates a state in which a response to the assistance request for the target job “BookCover-102” has been sent from the color adjustment assistance system 40. As a result, in the job color adjustment result display area 1201, the status corresponding to the target job “BookCover-102” is updated to “response being confirmed”, and the assistance request screen 1200 displays an attached file display area 1222, a download button 1223, an additional question button 1232, a completion button 1233, and a withdrawal button 1234.

Specifically, the display control unit 209 adds the service provider comment included in the response sent from the information notification unit 407 to the history in the history display area 1221. Further, the display control unit 209 displays, in the attached file display area 1222, the file name of the attached file provided by the service provider, which is included in the response sent from the information notification unit 407. By pressing the download button 1223, the user (print service provider) can download the attached file with the file name displayed in the attached file display area 1222.

The additional question button 1232 is a button for transmitting a comment input by the user in the comment input area 1211 and an attached file that has been attached by the operation of the file attachment button 1212, along with an indication of the additional question, to the color adjustment assistance system 40 in response to the response sent from the information notification unit 407. This allows the user to submit a further response to the response from the service provider, two-way communication sessions can be repeated between the user and the service provider to facilitate the solution of the problem related to color adjustment.

The completion button 1233 is a button pressed when the user (print service provider) determines that the response made by the service provider sent from the information notification unit 407 has solved the problem related to color adjustment. When the completion button 1233 is pressed, the display control unit 209 updates the status of the corresponding target job or target device to “completed”.

The withdrawal button 1234 is a button pressed when the user (print service provider) determines that the response made by the service provider sent from the information notification unit 407 cannot solve the problem related to color adjustment. When the withdrawal button 1234 is pressed, the display control unit 209 updates the status of the corresponding target job or target device to “withdrawn” (unsolved).

In a case where the analysis tab 2130 and the log tab 2140 are selected on the job color adjustment assistance screen 2100 described above, information having content similar to that displayed in a case where the analysis tab 2030 and the log tab 2040 are selected on the device color adjustment assistance screen 2000 described above is displayed.

### Flow of Overall Operation of Information Processing System

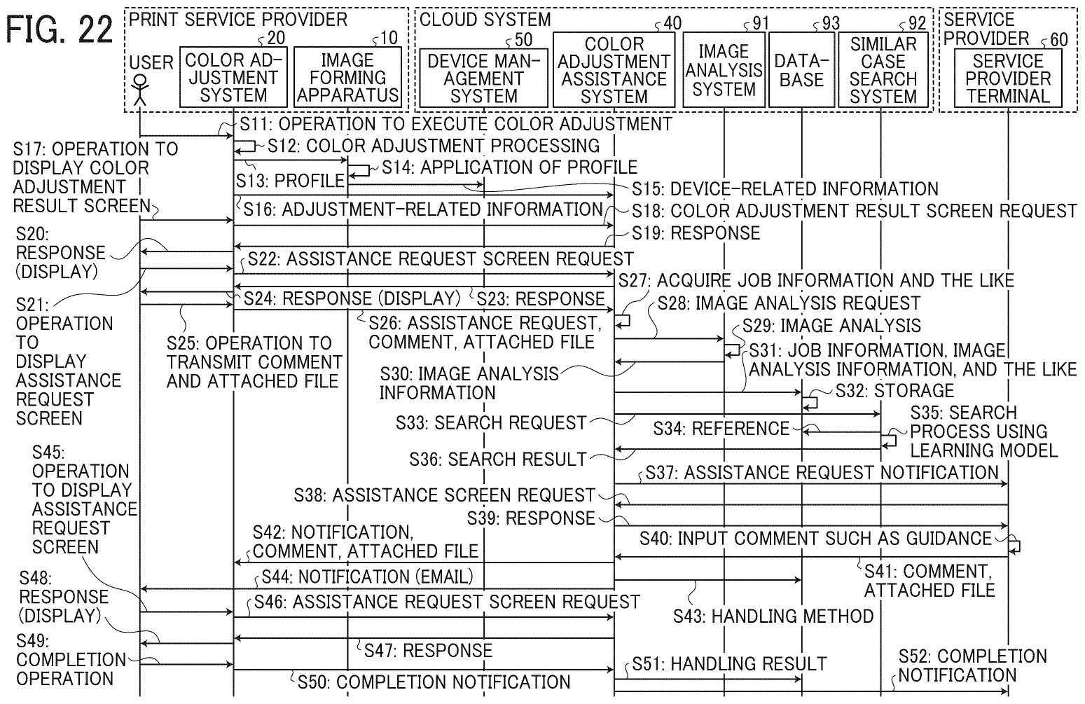

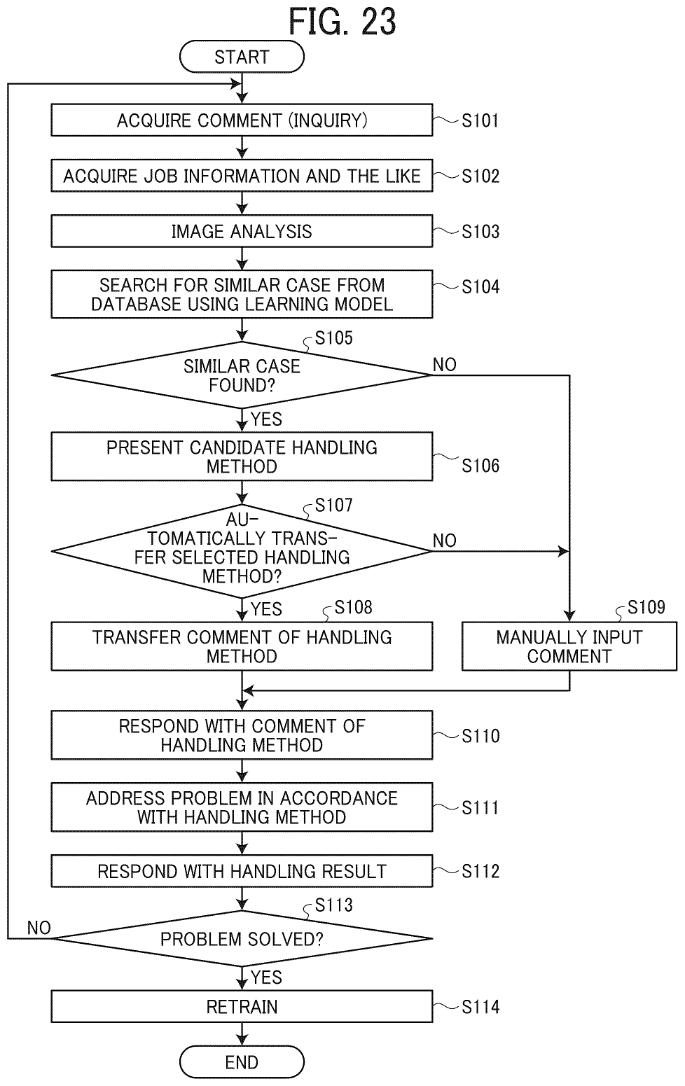

FIG. 22 is a sequence diagram illustrating an example of a flow of an overall operation of the information processing system 1. FIG. 23 is a flowchart illustrating an example of a flow of an assist process for the information processing system 1. The flow of the overall operation of the information processing system 1 will be described with reference to FIGS. 22 and 23.

The user (print service provider) performs an operation to execute the device color adjustment or the job color adjustment through the input unit 208 of the color adjustment system 20. In step S11, the color adjustment system 20 receives the execution operation from the user.

In step S12, the color information acquisition unit 203 of the color adjustment system 20 acquires read data from the image reading device 30 via the communication unit 201. The read data includes measured color values (e.g., Lab values) obtained by the image reading device 30 performing a reading process on the reproduced image print RIP and the color chart CC, which are printed by the image forming apparatus 10, in the device color adjustment and on the print sample PS in the job color adjustment. In the job color adjustment, the calculation unit 204 of the color adjustment system 20 calculates the color difference between the image of the print sample PS and each of reproduction images obtained before and after the color matching. For example, the calculation unit 204 calculates a color difference between the pixel value of each pixel in the image of the print sample PS and the pixel value of the corresponding pixel in each of the reproduction images obtained before and after the color matching. The calculation unit 204 further calculates a color difference average that is an average value of these color differences. The color difference average of the color differences between the image of the print sample PS and the reproduction image obtained before the color matching may be referred to as pre-adjustment ΔE, and the color difference average of the color differences between the image of the print sample PS and the reproduction image obtained after the color matching may be referred to as post-adjustment ΔE. In the device color adjustment, the calculation unit 204 calculates, from the read data of the color chart CC, an average value (average ΔE) and a maximum color difference (maximum ΔE) of color differences between patches. The determination results for the color differences are stored in the storage unit 210 as a history of color adjustment. In the job color adjustment, the color adjustment unit 205 of the color adjustment system 20 performs adjustment such that the colors of the reproduction images match the colors of the image of the print sample PS to generate an input profile. In the device color adjustment, since the color value of each patch of the color chart CC is known, the color adjustment unit 205 performs a color adjustment process according to a known technique such that the measured color values of patches corresponding to color adjustment patches reproduce the color values of the respective patches of the color chart CC, and creates an output profile.

In step S13, the profile transmission unit 206 of the color adjustment system 20 transmits the profile generated by the color adjustment unit 205 to the image forming apparatus 10 via the communication unit 201.

In step S14, the print control unit 103 of the image forming apparatus 10 applies the profile transmitted from the profile transmission unit 206.

In step S15, the device information transmission unit 105 of the image forming apparatus 10 periodically collects device-related information of the image forming apparatus 10 and transmits the collected device-related information to the device management system 50 via the communication unit 101. Then, the information collection unit 502 of the device management system 50 collects (acquires) the device-related information from the image forming apparatus 10 via the communication unit 501. The information collection unit 502 stores the collected device-related information in the storage unit 504.

In step S16, the color adjustment information transmission unit 207 of the color adjustment system 20 collects adjustment-related information related to the job color adjustment and the device color adjustment for the image forming apparatus 10, and transmits the collected adjustment-related information to the color adjustment assistance system 40 via the communication unit 201. The information acquisition unit 403 of the color adjustment assistance system 40 acquires the adjustment-related information from the color adjustment system 20 via the communication unit 401. The information acquisition unit 403 stores the acquired adjustment-related information in the storage unit 408.

The print service provider, or the user, performs an operation to display the job color adjustment result screen 1100 (or the device color adjustment result screen 1000) through the input unit 208 of the color adjustment system 20. In step S17, the color adjustment system 20 receives the display operation from the user.

In step S18, the display control unit 209 of the color adjustment system 20 transmits a request to display the job color adjustment result screen 1100 (or the device color adjustment result screen 1000) (i.e., a color adjustment result screen request) to the color adjustment assistance system 40 via the communication unit 201.

In step S19, in response to the request, the UI unit 402 of the color adjustment assistance system 40 transmits screen information of the job color adjustment result screen 1100 (or the device color adjustment result screen 1000) to the color adjustment system 20 via the communication unit 401. Along with the transmission of the screen information from the UI unit 402, the information transmission unit 404 transmits adjustment-related information and device-related information to be used to display the job color adjustment result screen 1100 (or the device color adjustment result screen 1000) to the color adjustment system 20.

In step S20, the display control unit 209 causes the display 808 to display the job color adjustment result screen 1100 (or the device color adjustment result screen 1000).

The user presses the assistance request button 1112 (or the assistance request button 1012) to make an assistance request for a color adjustment result indicating the “NG” result displayed on the job color adjustment result screen 1100 (or the device color adjustment result screen 1000). In step S21, the color adjustment system 20 receives the pressing of the assistance request button 1112.

In step S22, the display control unit 209 transmits a request to display the assistance request screen 1200 (an assistance request screen request) to the color adjustment assistance system 40 via the communication unit 201.

In step S23, in response to the request, the UI unit 402 of the color adjustment assistance system 40 transmits screen information of the assistance request screen 1200 to the color adjustment system 20 via the communication unit 401. Along with the transmission of the screen information from the UI unit 402, the information transmission unit 404 transmits adjustment-related information and device-related information to be used to display the assistance request screen 1200 to the color adjustment system 20.

In step S24, the display control unit 209 causes the display 808 to display the assistance request screen 1200.

The user selects a target job or a target device for which the user makes an assistance request, in the job color adjustment result display area 1201 or the device color adjustment result display area 1202 of the assistance request screen 1200. Then, the user inputs, to the comment input area 1211, a comment such as a question or a request to solve the problem related to color adjustment for which the determination result for the selected target job or target device is “NG”. The user operates the file attachment button 1212 to select an attached file, as appropriate. Then, the user presses the submit button 1231. In step S25, the color adjustment system 20 receives the pressing of the submit button 1231.

When the user presses the submit button 1231, in step S26, the color adjustment information transmission unit 207 transmits the assistance request and adjustment-related information, namely, the comment input in the comment input area 1211 and the attached file that has been attached by the operation of the file attachment button 1212, to the color adjustment assistance system 40 via the communication unit 201. The color adjustment information transmission unit 207 may transmit, along with the information described above, information on the image forming apparatus 10 to be subjected to the target color adjustment (target device information) and a history of the color adjustment performed on the image forming apparatus 10 by the color adjustment system 20, as adjustment-related information, to the color adjustment assistance system 40.

When the communication unit 401 of the color adjustment assistance system 40 receives the assistance request from the color adjustment system 20, in step S27, the search information acquisition unit 409 of the color adjustment assistance system 40 acquires job information and a support history from the information acquired by the information acquisition unit 403. The search information acquisition unit 409 acquires the document data and the read data of the print sample PS and the reproduced image print RIP from the adjustment-related information acquired by the information acquisition unit 403.

In step S28, the image analysis request unit 410 of the color adjustment assistance system 40 transmits an image analysis request to the image analysis system 91, together with the document data and the read data of the print sample PS and the reproduced image print RIP acquired by the search information acquisition unit 409.

In step S29, in response to receipt of the image analysis request from the color adjustment assistance system 40 via the communication unit 911, the image analysis unit 912 of the image analysis system 91 performs image analysis on the document data and the read data of the print sample PS and the reproduced image print RIP received together with the image analysis request.

In step S30, the image analysis unit 912 transmits image analysis information indicating a result of the image analysis to the color adjustment assistance system 40 via the communication unit 911.

In step S31, the image analysis request unit 410 receives image analysis information indicating the result of image analysis from the image analysis system 91. In step S32, the image analysis request unit 410 stores the job information, the support history, the document data, and the read data of the print sample PS and the reproduced image print RIP acquired by the search information acquisition unit 409, and the image analysis information received from the image analysis system 91 in the database 93 in association with each other for each job, as illustrated in FIG. 8 described above.

In step S33, the search request unit 411 of the color adjustment assistance system 40 transmits a request to search for a similar case related to the problem with the job color adjustment to the similar case search system 92, together with the job information and the support history acquired by the search information acquisition unit 409 and the image analysis information received by the image analysis request unit 410.

In steps S34 and S35, in response to receipt of the search request from the color adjustment assistance system 40 via the communication unit 921, the search unit 923 of the similar case search system 92 uses the learning model stored in the storage unit 924 to search for a similar case related to the problem with the job color adjustment by using the job information, the support history, and the image analysis information received together with the search request. Specifically, the search unit 923 extracts a phenomenon from the received support history, inputs the received job information and image analysis information and the extracted phenomenon as input data to the learning model, and acquires candidate handling methods for the problem with the job color adjustment output from the learning model. The search unit 923 is not limited to receiving the job information, the support history, and the image analysis information together with the search request from the color adjustment assistance system 40, and may acquire the job information, the support history, and the image analysis information by referring to the information stored in the database 93 from the color adjustment assistance system 40.

In step S36, the search unit 923 transmits a search result including the candidate handling methods obtained from the learning model to the color adjustment assistance system 40 via the communication unit 921.

In step S37, the communication unit 401 of the color adjustment assistance system 40 notifies the service provider terminal 60 of an assistance request from the color adjustment system 20. In this case, the communication unit 401 may transmit a notification to the service provider terminal 60 or an information terminal or the like possessed by the service provider via email.

In step S38, the service provider performs an operation to display the device color adjustment assistance screen 2000 or the job color adjustment assistance screen 2100 in accordance with whether the assistance request of which the service provider terminal 60 is notified is related to the device color adjustment or the job color adjustment. The following description will be given on the assumption that the assistance request is related to the job color adjustment. When the service provider performs an operation to display the job color adjustment assistance screen 2100 as illustrated in FIG. 18 through the input unit 602 of the service provider terminal 60, the display control unit 603 transmits a request to display the job color adjustment assistance screen 2100 to the color adjustment assistance system 40 via the communication unit 601.

In step S39, in response to the request, the UI unit 402 of the color adjustment assistance system 40 transmits screen information of the job color adjustment assistance screen 2100 to the service provider terminal 60 via the communication unit 401. Along with the transmission of the screen information from the UI unit 402, the information transmission unit 404 transmits adjustment-related information and device-related information to be used to display the job color adjustment assistance screen 2100 to the service provider terminal 60.

The information transmission unit 404 further transmits a search result including the candidate handling methods received from the similar case search system 92 by the communication unit 401 to the service provider terminal 60. Then, the display control unit 603 causes the display 808 to display the job color adjustment assistance screen 2100.

In step S40, the service provider selects at least one of the adjustment result tab 2120, the analysis tab 2130, the log tab 2140, and the assist tab 2150 on the job color adjustment assistance screen 2100 to check information related to the adjustment-related information and the device-related information. For example, in response to the service provider selecting the assist tab 2150, the display control unit 603 causes the display 808 to display the job color adjustment assistance screen 2100 and, as illustrated in FIG. 19, automatically display the candidate handling method dialog box 2160 on the job color adjustment assistance screen 2100. The display of the candidate handling method dialog box 2160 presents candidate handling methods found by the similar case search system 92. The service provider selects one or more candidate handling methods by pressing the candidate handling methods in the candidate handling method display area 2161. Then, in response to the service provider pressing the OK button 2162, the analysis unit 405 of the color adjustment assistance system 40 automatically generates a comment indicating the handling methods corresponding to the candidate handling methods selected in the candidate handling method display area 2161, and the display control unit 603 displays (transfers) the comment in the comment input area 2151. Then, the display control unit 603 hides the candidate handling method dialog box 2160. In this case, the service provider can edit the comment or add information to the comment in the comment input area 2151, by performing an operation input through the input unit 602. Further, the service provider operates the file attachment button 2152 to select an attached file such as a profile created by the service provider as a response to the assistance request, as appropriate.

In step S41, in response to the service provider pressing the submit button 2155, the communication unit 601 transmits the service provider comment displayed in the comment input area 2151 (i.e., the response made by the service provider to the assistance request, based on the candidate handling methods displayed in the candidate handling method display area 2161) and the attached file that has been attached by the operation of the file attachment button 2152 to the color adjustment assistance system 40 as a response to the assistance request. Then, the response acquisition unit 406 of the color adjustment assistance system 40 acquires the comment and the attached file.

In step S42, the information notification unit 407 of the color adjustment assistance system 40 notifies the color adjustment system 20 of the response (the comment and the attached file) acquired by the response acquisition unit 406 via the communication unit 401.

In step S43, the response acquisition unit 406 adds the comment (handling method) acquired in response to the assistance request to the support history acquired by the search information acquisition unit 409, and stores the resulting support history in the database 93 in association with the corresponding job.

In step S44, the information notification unit 407 may provide a notification to an information terminal or the like possessed by the user via email.

The user confirms that the status of the color adjustment result indicating the “NG” result displayed on the job color adjustment result screen 1100 has been updated to “response being confirmed”, based on the notification, and then presses the assistance request button 1112. In step S45, the color adjustment system 20 receives the pressing of the assistance request button 1112.

In step S46, the display control unit 209 transmits a request to display the assistance request screen 1200 (an assistance request screen request) to the color adjustment assistance system 40 via the communication unit 201.

In step S47, in response to the request, the UI unit 402 transmits the screen information of the assistance request screen 1200 to the color adjustment system 20 via the communication unit 401. Along with the transmission of the screen information from the UI unit 402, the information transmission unit 404 transmits adjustment-related information and device-related information to be used to display the assistance request screen 1200 to the color adjustment system 20.

In step S48, the display control unit 209 causes the display 808 to display the assistance request screen 1200. In this case, the display control unit 209 reflects the comment of the response sent from the information notification unit 407 in the history display area 1221, and reflects the attached file of the response in the attached file display area 1222. By pressing the download button 1223, the user (print service provider) can download the attached file with the file name displayed in the attached file display area 1222. Accordingly, the user (print service provider) can check the comment related to the handling method displayed in the history display area 1221 and address the problem related to the job color adjustment in accordance with the handling method. The user can also input, as appropriate, a comment on an additional question in the comment input area 1211, attach a new attached file by operating the file attachment button 1212, and press the additional question button 1232 to transmit the comment and the attached file, along with an indication of the additional question, to the color adjustment assistance system 40.

When the user (print service provider) determines that the response made by the service provider sent from the information notification unit 407 has solved the problem related to color adjustment, the user presses the completion button 1233. In step S49, in response to receipt of the pressing of the completion button 1233, the display control unit 209 updates the status of the corresponding target device to “completed”. On the other hand, when the user (print service provider) determines that the response made by the service provider sent from the information notification unit 407 has not solved the problem related to color adjustment, the user presses the withdrawal button 1234. When the withdrawal button 1234 is pressed, the display control unit 209 updates the status of the corresponding target job or target device to “withdrawn” (unsolved).

In step S50, the display control unit 209 transmits a completion notification (“problem solved” or “problem unsolved”) to the color adjustment assistance system 40 via the communication unit 201.

In step S51, the communication unit 401 stores the handling result (“problem solved” or “problem unsolved”) indicated by the received completion notification in the database 93 in association with the corresponding job. The information stored in the database 93 is used by the learning unit 922 to retrain the learning model. Accordingly, highly accurate inference of a candidate handling method by using the learning model can be achieved.

In step S52, the communication unit 401 of the color adjustment assistance system 40 transfers the completion notification to the service provider terminal 60.

The overall operation of the information processing system 1 is performed according to an example of the flow illustrated in steps S11 to S52 described above. The operation (assist process) in steps S26 to S52 will be described in detail with reference to FIG. 23.

When the user presses the submit button 1231 on the assistance request screen 1200, in step S101, the color adjustment information transmission unit 207 of the color adjustment system 20 transmits the assistance request and adjustment-related information, namely, the comment (inquiry) input in the comment input area 1211 and the attached file that has been attached by the operation of the file attachment button 1212, to the color adjustment assistance system 40 via the communication unit 201. Then, the process proceeds to step S102.

When the communication unit 401 of the color adjustment assistance system 40 receives the assistance request from the color adjustment system 20, in step S102, the search information acquisition unit 409 of the color adjustment assistance system 40 acquires job information and a support history from the information acquired by the information acquisition unit 403. The search information acquisition unit 409 acquires the document data and the read data of the print sample PS and the reproduced image print RIP from the adjustment-related information acquired by the information acquisition unit 403. Then, the process proceeds to step S103.

In step S103, the image analysis request unit 410 of the color adjustment assistance system 40 transmits an image analysis request to the image analysis system 91, together with the document data and the read data of the print sample PS and the reproduced image print RIP acquired by the search information acquisition unit 409. In response to receipt of the image analysis request from the color adjustment assistance system 40 via the communication unit 911, the image analysis unit 912 of the image analysis system 91 performs image analysis on the document data and the read data of the print sample PS and the reproduced image print RIP received together with the image analysis request. The image analysis unit 912 transmits image analysis information indicating a result of the image analysis to the color adjustment assistance system 40 via the communication unit 911. Then, the image analysis request unit 410 receives image analysis information indicating the result of image analysis from the image analysis system 91. Further, the image analysis request unit 410 stores the job information, the support history, the document data, and the read data of the print sample PS and the reproduced image print RIP acquired by the search information acquisition unit 409, and the image analysis information received from the image analysis system 91 in the database 93 in association with each other for each job. Then, the process proceeds to step S104.

In step S104, the search request unit 411 of the color adjustment assistance system 40 transmits a request to search for a similar case related to the problem with the job color adjustment to the similar case search system 92, together with the job information and the support history acquired by the search information acquisition unit 409 and the image analysis information received by the image analysis request unit 410. In response to receipt of the search request from the color adjustment assistance system 40 via the communication unit 921, the search unit 923 of the similar case search system 92 uses the learning model stored in the storage unit 924 to search for a similar case related to the problem with the job color adjustment by using the job information, the support history, and the image analysis information received together with the search request. Specifically, the search unit 923 extracts a phenomenon from the received support history, inputs the received job information and image analysis information and the extracted phenomenon as input data to the learning model, and acquires candidate handling methods for the problem with the job color adjustment output from the learning model. Then, the process proceeds to step S105.

If a similar case related to the problem with the job color adjustment is found in step S105, that is, candidate handling methods are found (step S105: Yes), the process proceeds to step S106. If no candidate handling method is found (step S105: No), the process proceeds to step S109.

In step S106, the search unit 923 transmits a search result including the candidate handling methods obtained from the learning model to the color adjustment assistance system 40 via the communication unit 921. The communication unit 401 of the color adjustment assistance system 40 notifies the service provider terminal 60 of an assistance request from the color adjustment system 20. The service provider performs an operation to display the device color adjustment assistance screen 2000 or the job color adjustment assistance screen 2100 in accordance with whether the assistance request of which the service provider terminal 60 is notified is related to the device color adjustment or the job color adjustment. The following description will be given on the assumption that the assistance request is related to the job color adjustment. When the service provider performs an operation to display the job color adjustment assistance screen 2100 as illustrated in FIG. 18 through the input unit 602 of the service provider terminal 60, the display control unit 603 transmits a request to display the job color adjustment assistance screen 2100 to the color adjustment assistance system 40 via the communication unit 601. In response to the request, the UI unit 402 of the color adjustment assistance system 40 transmits screen information of the job color adjustment assistance screen 2100 to the service provider terminal 60 via the communication unit 401. Along with the transmission of the screen information from the UI unit 402, the information transmission unit 404 transmits adjustment-related information and device-related information to be used to display the job color adjustment assistance screen 2100 to the service provider terminal 60. The information transmission unit 404 further transmits a search result including the candidate handling methods received from the similar case search system 92 by the communication unit 401 to the service provider terminal 60. Then, the display control unit 603 causes the display 808 to display the job color adjustment assistance screen 2100. In response to the service provider selecting the assist tab 2150 on the job color adjustment assistance screen 2100, the display control unit 603 causes the display 808 to display the job color adjustment assistance screen 2100 and, as illustrated in FIG. 19, automatically display the candidate handling method dialog box 2160 on the job color adjustment assistance screen 2100. The display of the candidate handling method dialog box 2160 presents candidate handling methods found by the similar case search system 92. Then, the process proceeds to step S107.

If it is determined in step S107 that the service provider has selected a candidate handling method in the candidate handling method display area 2161 in the candidate handling method dialog box 2160 (if a comment is to be automatically transferred from the selected candidate handling method) (step S107: Yes), the process proceeds to step S108. On the other hand, if it is determined that no candidate handling method is selected in the candidate handling method display area 2161 in the candidate handling method dialog box 2160 (step S107: No), the process proceeds to step S109.

The service provider selects one or more candidate handling methods by pressing the candidate handling methods in the candidate handling method display area 2161. In response to the service provider pressing the OK button 2162, in step S108, the analysis unit 405 of the color adjustment assistance system 40 automatically generates a comment indicating the handling methods corresponding to the candidate handling methods selected in the candidate handling method display area 2161, and the display control unit 603 displays (transfers) the comment in the comment input area 2151. Then, the display control unit 603 hides the candidate handling method dialog box 2160. Then, the process proceeds to step S110.

The service provider manually inputs a comment indicating a handling method to the comment input area 2151 by operating the input unit 602. When the input is received in step S109, the process proceeds to step S110.

In response to the service provider pressing the submit button 2155, in step S110, the communication unit 601 transmits the service provider comment displayed in the comment input area 2151 and the attached file that has been attached by the operation of the file attachment button 2152 to the color adjustment assistance system 40 as a response to the assistance request. Then, the response acquisition unit 406 of the color adjustment assistance system 40 acquires the comment and the attached file. Then, the information notification unit 407 of the color adjustment assistance system 40 notifies the color adjustment system 20 of the response (the comment and the attached file) acquired by the response acquisition unit 406 via the communication unit 401. Then, the process proceeds to step S111.

The user confirms that the status of the color adjustment result indicating the “NG” result displayed on the job color adjustment result screen 1100 has been updated to “response being confirmed”, based on the notification, and then presses the assistance request button 1112. In step S111, in response to receipt of the pressing of the assistance request button 1112, the display control unit 209 transmits a request to display the assistance request screen 1200 (an assistance request screen request) to the color adjustment assistance system 40 via the communication unit 201. In response to the request, the UI unit 402 transmits the screen information of the assistance request screen 1200 to the color adjustment system 20 via the communication unit 401. Along with the transmission of the screen information from the UI unit 402, the information transmission unit 404 transmits adjustment-related information and device-related information to be used to display the assistance request screen 1200 to the color adjustment system 20. Then, the display control unit 209 causes the display 808 to display the assistance request screen 1200. In this case, the display control unit 209 reflects the comment of the response sent from the information notification unit 407 in the history display area 1221, and reflects the attached file of the response in the attached file display area 1222. Accordingly, the user (print service provider) can check the comment related to the handling method displayed in the history display area 1221 and address the problem related to the job color adjustment in accordance with the handling method. Then, the process proceeds to step S112.

When the user (print service provider) determines that the response made by the service provider sent from the information notification unit 407 has solved the problem related to color adjustment, the user presses the completion button 1233. In step S112, in response to receipt of the pressing of the completion button 1233, the display control unit 209 updates the status of the corresponding target device to “completed”. On the other hand, when the user (print service provider) determines that the response made by the service provider sent from the information notification unit 407 has not solved the problem related to color adjustment, the user presses the withdrawal button 1234. When the withdrawal button 1234 is pressed, the display control unit 209 updates the status of the corresponding target job or target device to “withdrawn” (unsolved). Thus, the display control unit 209 transmits a completion notification (“problem solved” or “problem unsolved”) to the color adjustment assistance system 40 via the communication unit 201. Then, the process proceeds to step S113.

If the problem related to the job color adjustment has been solved in step S113 (step S113: Yes), the process proceeds to step S114. If the problem related to the job color adjustment has not been solved (step S113: No), the process returns to step S101.

In step S114, the communication unit 401 stores the handling result (“problem solved” or “problem unsolved”) indicated by the received completion notification in the database 93 in association with the corresponding job. Then, the learning unit 922 retrains the learning model by using the handling result stored in the database 93 in association with the job. Accordingly, highly accurate inference of a candidate handling method by using the learning model can be achieved. Then, the assist process ends.

As described above, in the information processing system 1, the information acquisition unit 403 acquires job information related to the image forming apparatus 10 and a support history of interactions between a user of the image forming apparatus 10 and a service provider of a service, the color adjustment information transmission unit 207 transmits an assistance request for a problem related to color adjustment to the color adjustment assistance system 40 in response to the user operating the input unit 208 (the keyboard 811 or the mouse 812) of the color adjustment system 20, the search unit 923 obtains a candidate handling method for the problem related to color adjustment in response to the assistance request by using at least the job information and the support history, from a learning model generated by machine learning to infer a candidate handling method for the problem related to color adjustment, the UI unit 402 causes the display device (the display 808) used by the service provider of the service to display the candidate handling method obtained by the search unit 923 on the job color adjustment assistance screen 2100 for displaying information for assisting in solving the problem related to color adjustment, and the information notification unit 407 notifies the color adjustment system 20 of a response that is made by the service provider in response to the request and that is based on the candidate handling method displayed by the UI unit 402. This configuration allows even a low-skilled operator to solve a problem related to color adjustment quickly in response to the presentation of a solution to the problem.

While the embodiment described above has described assistance processing related to color adjustment (job color adjustment and device color adjustment), the assistance processing may also be applied to general image quality adjustment including the color adjustment described above and the adjustment of density unevenness. The color adjustment system 20 described above is an example of the “image quality adjustment system” disclosed herein, and the color adjustment assistance system 40 is an example of the “image quality adjustment assistance system” disclosed herein.

In the embodiment described above, in a case where at least one of the functional units of the image forming apparatus 10, the color adjustment system 20, the color adjustment assistance system 40, the device management system 50, the service provider terminal 60, the image analysis system 91, and the similar case search system 92 is implemented by execution of a program, the program is pre-installed and provided in a ROM or the like. In the embodiment described above, the programs to be executed by the image forming apparatus 10, the color adjustment system 20, the color adjustment assistance system 40, the device management system 50, the service provider terminal 60, the image analysis system 91, and the similar case search system 92 may be recorded and provided on a computer-readable recording medium such as a compact disc read-only memory (CD-ROM), a flexible disk (FD), a compact disc recordable (CD-R), or a DVD in an installable or executable file format. In the embodiment described above, the programs to be executed by the image forming apparatus 10, the color adjustment system 20, the color adjustment assistance system 40, the device management system 50, the service provider terminal 60, the image analysis system 91, and the similar case search system 92 may be stored in a computer connected to a network such as the Internet and downloaded and provided via the network. In the embodiment described above, the programs to be executed by the image forming apparatus 10, the color adjustment system 20, the color adjustment assistance system 40, the device management system 50, the service provider terminal 60, the image analysis system 91, and the similar case search system 92 may be provided or distributed via a network such as the Internet. In the embodiment described above, the programs to be executed by the image forming apparatus 10, the color adjustment system 20, the color adjustment assistance system 40, the device management system 50, the service provider terminal 60, the image analysis system 91, and the similar case search system 92 have a module configuration including at least any of the functional units described above. As actual hardware, the CPU 701 (and the CPU 801) reads the programs from the storage devices described above (e.g., the system memory 702, the auxiliary storage device 708, and the auxiliary storage device 805) and executes the programs, thereby loading and generating the functional units described above on the main storage device.

### Aspects of the Present Disclosure are as Follows.

In a first aspect, an information processing system includes an image quality adjustment system and an image quality adjustment assistance system. The image quality adjustment system performs image quality adjustment on one or more image forming apparatuses. The image quality adjustment assistance system provides a service for solving a problem related to the image quality adjustment. The information processing system includes an acquisition unit, a transmission unit, a search unit, a display control unit, and a notification unit. The acquisition unit acquires job information related to the one or more image forming apparatuses and history information of an interaction between a user of the one or more image forming apparatuses and a service provider of the service. The transmission unit transmits an assistance request for the problem related to the image quality adjustment to the image quality adjustment assistance system based on an operation performed on an input unit by the user. The search unit obtains a candidate handling method for the problem related to the image quality adjustment in response to the assistance request by using at least the job information and the history information, the candidate handling method being obtained from a learning model generated by machine learning to infer a candidate handling method for the problem related to the image quality adjustment. The display control unit causes a display device used by the service provider to display the candidate handling method obtained by the search unit on an assistance screen that displays information for assisting in solving the problem related to the image quality adjustment. The notification unit notifies the image quality adjustment system of a response made by the service provider in response to the assistance request for the problem related to the image quality adjustment, the response being based on the candidate handling method displayed by the display control unit.

According to a second aspect, the information processing system of the first aspect further includes an analysis unit. The candidate handling method includes a plurality of candidate handling methods, and the display control unit causes the display device to display the plurality of candidate handling methods on the assistance screen. The analysis unit automatically generates a comment indicating a handling method corresponding to a candidate handling method selected by the service provider from among the plurality of candidate handling methods displayed by the display control unit. The display control unit causes the display device to display the comment generated by the analysis unit on the assistance screen.

According to a third aspect, the information processing system of the first aspect or the second aspect further includes a database that stores the job information and the history information acquired by the acquisition unit in association with each other for each job.

According to a fourth aspect, in the information processing system of the third aspect, the candidate handling method includes a plurality of candidate handling methods, the display control unit causes the display device to display the plurality of candidate handling methods on the assistance screen, and the database stores, in association with the job, a candidate handling method selected by the service provider from among the plurality of candidate handling methods displayed by the display control unit.

According to a fifth aspect, in the information processing system of the fourth aspect, the database stores, in association with the job, a handling result indicating whether the user has solved the problem related to the image quality adjustment by using the response, and the handling result stored in the database is used to retrain the learning model.

According to a sixth aspect, the information processing system of any one of the third aspect to the fifth aspect further includes an image analysis unit. The acquisition unit acquires image-related data related to the image quality adjustment for the one or more image forming apparatuses. The image analysis unit performs image analysis related to the image quality adjustment, based on the image-related data acquired by the acquisition unit. The search unit obtains the candidate handling method from the learning model by using the job information, the history information, and a result of the image analysis performed by the image analysis unit.

According to a seventh aspect, in the information processing system of the sixth aspect, the database stores the result of the image analysis performed by the image analysis unit in association with the job.

According to an eighth aspect, the information processing system of any one of the first aspect to the seventh aspect further includes a detection unit. The detection unit detects the problem related to the image quality adjustment, based on satisfaction of a predetermined condition. The transmission unit transmits the assistance request to the image quality adjustment assistance system, based on detection of the problem related to the image quality adjustment by the detection unit.

In a ninth aspect, an information processing apparatus for communicating with an image quality adjustment system that performs image quality adjustment on one or more image forming apparatuses and providing a service for solving a problem related to the image quality adjustment includes an acquisition unit, a reception unit, a search request unit, a display control unit, and a notification unit. The acquisition unit acquires job information related to the one or more image forming apparatuses and history information of an interaction between a user of the one or more image forming apparatuses and a service provider of the service. The reception unit receives an assistance request for the problem related to the image quality adjustment from the image quality adjustment system based on an operation performed on an input unit by the user. The search request unit performs a search request to obtain a candidate handling method for the problem related to the image quality adjustment in response to the assistance request by using at least the job information and the history information, the candidate handling method being obtained from a learning model generated by machine learning to infer a candidate handling method for the problem related to the image quality adjustment. The display control unit causes a display device used by the service provider to display the candidate handling method obtained by the search request unit on an assistance screen that displays information for assisting in solving the problem related to the image quality adjustment. The notification unit notifies the image quality adjustment system of a response made by the service provider in response to the assistance request for the problem related to the image quality adjustment, the response being based on the displayed candidate handling method.

In a tenth aspect, an information processing method for an information processing system, the information processing system including an image quality adjustment system to perform image quality adjustment on one or more image forming apparatuses, and an image quality adjustment assistance system to provide a service for solving a problem related to the image quality adjustment, includes acquiring job information related to the one or more image forming apparatuses and history information of an interaction between a user of the one or more image forming apparatuses and a service provider of the service; transmitting an assistance request for the problem related to the image quality adjustment to the image quality adjustment assistance system based on an operation performed on an input unit by the user; obtaining a candidate handling method for the problem related to the image quality adjustment in response to the assistance request by using at least the job information and the history information, the candidate handling method being obtained from a learning model generated by machine learning to infer a candidate handling method for the problem related to the image quality adjustment; displaying, on a display device used by the service provider, the obtained candidate handling method on an assistance screen that displays information for assisting in solving the problem related to the image quality adjustment; and notifying the image quality adjustment system of a response made by the service provider in response to the assistance request for the problem related to the image quality adjustment, the response being based on the displayed candidate handling method.

In an eleventh aspect, a program causes a computer of an information processing system including an image quality adjustment system to perform image quality adjustment on one or more image forming apparatuses, and an image quality adjustment assistance system to provide a service for solving a problem related to the image quality adjustment, to execute acquiring job information related to the one or more image forming apparatuses and history information of an interaction between a user of the one or more image forming apparatuses and a service provider of the service; receiving an assistance request for the problem related to the image quality adjustment from the image quality adjustment system based on an operation performed on an input unit by the user; performing a search request to obtain a candidate handling method for the problem related to the image quality adjustment in response to the assistance request by using at least the job information and the history information, the candidate handling method being obtained from a learning model generated by machine learning to infer a candidate handling method for the problem related to the image quality adjustment; displaying, on a display device used by the service provider, the obtained candidate handling method on an assistance screen that displays information for assisting in solving the problem related to the image quality adjustment; and notifying the image quality adjustment system of a response made by the service provider in response to the assistance request for the problem related to the image quality adjustment, the response being based on the displayed candidate handling method.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising
circuitry configured to:
acquire job information related to one or more image forming apparatuses on which image quality adjustment are performed and history information of an interaction between a user of the one or more image forming apparatuses and a service provider of a service for solving a problem related to the image quality adjustment;
obtain a candidate handling method for the problem related to the image quality adjustment, in response to an assistance request for the problem related to the image quality adjustment based on an operation performed by the user, by using the job information and the history information, the candidate handling method being obtained from a learning model generated by machine learning to infer a candidate handling method for the problem related to the image quality adjustment;
cause a display device used by the service provider to display the obtained candidate handling method on an assistance screen, the assistance screen displaying information for assisting in solving the problem related to the image quality adjustment; and
send a notification indicating a response made by the service provider in response to the assistance request for the problem related to the image quality adjustment, the response being based on the displayed candidate handling method.

2. The information processing system according to claim 1, wherein the circuitry is configured to:
cause the display device to display a plurality of candidate handling methods on the assistance screen;
automatically generate a comment indicating a handling method corresponding to a candidate handling method selected by the service provider from among the displayed plurality of candidate handling methods; and
cause the display device to display the generated comment on the assistance screen.

3. The information processing system according to claim 1, further comprising a database that stores the acquired job information and the acquired history information in association with each other for each job.

4. The information processing system according to claim 3, wherein
the circuitry is configured to cause the display device to display a plurality of candidate handling methods on the assistance screen, and
the database stores, in association with the job, a candidate handling method selected by the service provider from among the displayed plurality of candidate handling methods.

5. The information processing system according to claim 4, wherein
the database stores, in association with the job, a handling result indicating whether the user has solved the problem related to the image quality adjustment by using the response, and
the handling result stored in the database is used to retrain the learning model.

6. The information processing system according to claim 3, wherein the circuitry is configured to:
acquire image-related data related to the image quality adjustment for the one or more image forming apparatuses;
perform image analysis related to the image quality adjustment, based on the acquired image-related data; and
obtain the candidate handling method from the learning model by using the job information, the history information, and a result of the image analysis.

7. The information processing system according to claim 6, wherein the database stores the result of the image analysis in association with the job.

8. The information processing system according to claim 1, wherein the circuitry includes:
first circuitry on an image quality adjustment assistance system; and
second circuitry on an image quality adjustment system,
the second circuitry being configured to transmit the assistance request for the problem to the image quality adjustment assistance system according to the operation performed by the user.

9. The information processing system according to claim 8, wherein the second circuitry is configured to:
detect the problem related to the image quality adjustment, based on satisfaction of a predetermined condition; and
transmit the assistance request to the image quality adjustment assistance system, based on detection of the problem related to the image quality adjustment.

10. An information processing apparatus communicable with an image quality adjustment system that performs image quality adjustment on one or more image forming apparatuses, the information processing apparatus comprising circuitry configured to:
acquire job information related to the one or more image forming apparatuses and history information of an interaction between a user of the one or more image forming apparatuses and a service provider, the service provider providing a service for solving a problem related to the image quality adjustment;
receive an assistance request for the problem related to the image quality adjustment from the image quality adjustment system based on an operation performed by the user;
perform a search request to obtain a candidate handling method for the problem related to the image quality adjustment in response to the assistance request by using at least the job information and the history information, the candidate handling method being obtained from a learning model generated by machine learning to infer a candidate handling method for the problem related to the image quality adjustment;
cause a display device used by the service provider to display the obtained candidate handling method on an assistance screen, the assistance screen displaying information for assisting in solving the problem related to the image quality adjustment; and
notify the image quality adjustment system of a response made by the service provider in response to the assistance request for the problem related to the image quality adjustment, the response being based on the displayed candidate handling method.

11. An information processing method for providing a service for solving a problem related to image quality adjustment performed on one or more image forming apparatuses, the information processing method comprising:
acquiring job information related to the one or more image forming apparatuses and history information of an interaction between a user of the one or more image forming apparatuses and a service provider of the service;
receiving an assistance request for the problem related to the image quality adjustment from an image quality adjustment system that performs the image quality adjustment based on an operation performed by the user;
obtaining a candidate handling method for the problem related to the image quality adjustment in response to the assistance request by using at least the job information and the history information, the candidate handling method being obtained from a learning model generated by machine learning to infer a candidate handling method for the problem related to the image quality adjustment;
displaying, on a display device used by the service provider, the obtained candidate handling method on an assistance screen, the assistance screen displaying information for assisting in solving the problem related to the image quality adjustment; and
notifying the image quality adjustment system of a response made by the service provider in response to the assistance request for the problem related to the image quality adjustment, the response being based on the displayed candidate handling method.
